(19) United States
(12) Patent Application Publication
(10) Pub. No.: US 2019/0014529 A1
(43) Pub. Date: Jan. 10, 2019

(54) Network-Based Flow Mobility For Multi Connectivity Devices

(71) Applicant: INTERDIGITAL PATENT HOLDINGS, INC., Wilmington, DE (US)

(72) Inventors: Dimitrios Karampatsis, Ruislip (GB); Pascal M. Adjakple, Great Neck, NY (US); Alexander Reznik, Pennington, NJ (US); Juan Carlos Zuniga, Montreal (CA); Guanzhou Wang, Brossard (CA)

(73) Assignee: INTERDIGITAL PATENT HOLDINGS, INC., Wilmington, DE (US)

(21) Appl. No.: 15/322,966

(22) PCT Filed: Jun. 30, 2015
(86) PCT No.: PCT/US2015/038686

§ 371 Date: Dec. 29, 2016

Related U.S. Application Data
(60) Provisional application No. 62/054,637, filed on Sep. 24, 2014.
(60) Provisional application No. 62/019,193, filed on Jun. 30, 2014.

(51) Int. Cl. H04W 40/36; H04W 36/00; H04W 40/02; H04W 76/12; H04W 88/16; H04L 12/715; H04W 40/24

(52) U.S. Cl. CPC H04W 40/36; H04W 36/0022; H04W 40/02; H04W 84/12; H04W 88/16; H04L 45/04; H04W 40/248; H04W 76/12

(57) ABSTRACT

Systems, methods, and instrumentalities are described for IP flow mobility. A WTRU may receive a trigger for initiating IFOM and/or create one or more routing rules. The WTRU may send the routing rules to a Trusted WLAN Access Network (TWAN) using signaling. A TWAN may receive routing rules from a WTRU using signaling. The TWAN may send the routing rules to a PDN gateway. The routing rules may be sent to the gateway using an S2a reference point. A TWAN may receive one or more routing rules from a PDN gateway. The TWAN may send the routing rules to a WTRU using signaling. The signaling may be one or more of: EAP signaling, Layer-3 (L3) signaling, WLCP signaling, IEEE 802.11 signaling, Non Access Stratum (NAS) signaling, and/or Layer-2 (L2) signaling.

### CROSS REFERENCE TO RELATED APPLICATIONS

This application is the National Stage Entry under 35 U.S.C. § 371 of Patent Cooperation Treaty Application PCT/US2015/038686, filed 30 Jun. 2015, which claims the benefit of U.S. Provisional Patent Application No. 62/019,193, filed 30 Jun. 2014; and U.S. Provisional Patent Application No. 62/054,637, filed 24 Sep. 2014; the contents of all of which are hereby incorporated by reference as if fully set-forth herein, for all purposes

### BACKGROUND

The WTRU-initiated Network-based IP flow mobility (NBIFOM) is IFOM based on network mobility protocols (General Packet Radio Service (GPRS) Tunneling Protocol (GTP) and Proxy Mobile Internet Protocol (PMIP)) where the WTRU initiates the IP flow mobility. Network-initiated NBIFOM is IFOM based on network mobility protocols (GTP and PMIP) where the network initiates the IP flow mobility. Wireless Local Area Network (WLAN) is a wireless computer network that links two or more devices using a wireless distribution techniques within a limited area. WLANs provide the ability to move around within a local coverage area and still be connected to the network. WLANs can provide a connection to the Internet. Many WLANs are based on IEEE 802.11 standards, marketed under the Wi-Fi brand name. WLAN 3GPP IP Access allows WLAN WTRUs to establish connectivity with External IP networks, such as 3G operator networks, private Intranets, or the Internet via the 3GPP system.

### SUMMARY

Systems, methods, and instrumentalities are described to send routing rules for IP flow mobility (IFOM), e.g., an IFOM between a WTRU and a packet data network (PDN) gateway. A Trusted WLAN Access Network (TWAN) may receive one or more routing rules from a WTRU using signaling. The TWAN may send the one or more routing rules to a PDN gateway (PGW). The one or more routing rules may be sent to the gateway using an S2a reference point. A TWAN may receive a message including one or more routing rules from a PDN gateway. The TWAN may send a signaling including the one or more routing rules to a WTRU. The signaling may be one of Extensible Authentication Protocol (EAP) signaling, Layer-3 (L3) signaling, WLAN Control Protocol (WLCP) signaling, IEEE 802.11 signaling, Non Access Stratum (NAS) signaling, or Layer-2 (L2) signaling.

A WTRU may receive a trigger for initiating IFOM and create one or more routing rules. The WTRU may send the one or more routing rules to a Trusted WLAN Access Network (TWAN) using signaling. The signaling may be one of EAP signaling, L3 signaling, WLCP signaling, IEEE 802.11 signaling, NAS signaling, or L2 signaling. The decision to trigger IFOM may be based on receiving a trigger from a Policy and Charging Rules Function (PCRF). The trigger may be received via one of an Access Network Discovery and Selection Function (ANDSF) policy or a Radio Access Network (RAN) rule.

One or more methods and/or apparatuses for wireless transmit/receive unit (WTRU)-initiated Network Based Internet Protocol (IP) Flow Mobility (NBIFOM) and network-initiated NBIFOM are contemplated. Methods for WTRU-initiated NBIFOM in a WTRU may include one or more of: connecting to 3GPP access and a wireless local area network (WLAN) access, triggering WTRU-initiated NBIFOM based on Access Network Discovery and Selection Function (ANDSF) policy, constructing one or more routing rules, transmitting the one or more routing rules to the packet data network (PDN) gateway (PGW) via WLAN signaling, receiving authorization from the PGW to initiate a WTRU-initiated NBIFOM procedure, and/or moving one or more flows to a target access based on information contained in the one or more routing rules.

Embodiments contemplate a wireless transmit/receive unit (WTRU) that may comprise a processor. The processor may be configured to establish communication via a first access network. The processor may be configured to establish communication via a second access network. The processor may be configured to direct a first Internet Protocol (IP) flow via the first access network. The processor may be configured to detect a loss of connectivity with the first access network. The processor may be configured to create one or more routing rules for redirection of the first IP flow via the second access network upon the loss of connectivity with the first access network. The WTRU may comprise a transmitter that may be configured to send an indication of the loss of connectivity with the first access network toward a node of a core network.

Embodiments contemplate a wireless transmit/receive unit (WTRU) that may comprise a processor. The processor may be configured to establish a multi-connection mode of communication. The processor may be configured to establish a connection with a first access network. The processor may be configured to establish a connection with a second access network. The processor may be configured to direct a first Internet Protocol (IP) flow via the first access network. The processor may be configured to initiate a Network-based IP flow mobility (NBIFOM) for the first IP flow. The processor may be configured to create one or more routing rules for redirection of the first IP flow via the second access network. The WTRU may be comprise a transmitter that may be configured to send the one or more routing rules for the redirection of the first IP flow via the second access network to a Trusted Wireless Local Access Network (TWAN) in a Wireless Local Access Network (WLAN) Control Protocol (WLCP) signal.

Embodiments contemplate a wireless transmit/receive unit (WTRU) that may comprise a processor. The processor may be configured at least to establish a multi-connection mode of communication. The processor may be configured to establish a connection with a first access network. The processor may be configured to establish a connection with a second access network. The processor may be configured to direct a first Internet Protocol (IP) flow via the first access network. The WTRU may comprise a receiver that may be configured to receive a Network-based IP flow mobility (NBIFOM) request for the first IP flow from a Trusted Wireless Local Access Network (TWAN) in a Wireless Local Access Network (WLAN) Control Protocol (WLCP) signal, the NBIFOM request including one or more routing rules for redirection of the first IP flow via the second access network.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and an example core network that may be used within the communications system illustrated in FIG. 1A.

FIG. 1E is a system diagram of another example radio access network and an example core network that may be used within the communications system illustrated in FIG. 1A.

FIG. 2 illustrates an example of an S2a-based mobility over GTP (SaMOG) architecture.

FIG. 3 illustrates an example Trusted WiFi Local Area Network (WLAN) Access Network architecture.

FIG. 4 illustrates an example of an Access Network Discovery and Selection Function (ANDSF) architecture.

FIG. 5 illustrates an example of an Extensible Authentication Protocol (EAP) re-authentication framework.

FIG. 6 illustrates an example of WTRU initiated IP flow mobility (IFOM) for a Single Connection mode using EAP signaling.

FIG. 7 illustrates an example of WTRU initiated IFOM for a Single Connection mode using L3 signaling.

FIG. 8 illustrates an example of WTRU-initiated network-based IFOM (NB-IFOM) for a Single Connection via WLCP signaling.

FIG. 9 illustrates an example of WTRU-initiated NB-IFOM for a Single Connection via L2 signaling.

FIG. 10 illustrates an example of network (NW)-initiated IFOM for a Single Connection mode via a WLAN access point using EAP signaling.

FIG. 11 illustrates an example of NW-initiated IFOM for a Single Connection mode via a WLAN access point using L3 messages.

FIG. 12 illustrates an example of NW-initiated IFOM for a Single Connection mode via a WLAN access point using WLCP protocol.

FIG. 13 illustrates an example of NW-initiated IFOM for a Single Connection mode via a WLAN access point using L2 based signaling.

FIG. 14 illustrates an example of NW-initiated IFOM for a Single Connection mode via a WLAN access point using an L2/L3 communication.

FIG. 15 illustrates an example of NW-initiated IFOM for a Single Connection mode via 3GPP signaling.

FIG. 16 illustrates an example of WTRU-initiated NB-IFOM for a Multi-Connection mode via WLCP signaling.

FIG. 17 illustrates an example of NW-initiated NB-IFOM for a Multi-Connection mode via WLCP signaling.

FIG. 18 illustrates an example of NW-initiated NB-IFOM for a Multi-Connection mode via 3GPP signaling.

FIG. 19 is a flow diagram for an example procedure after loss of WLAN access for GTP S5/S8.

FIG. 20 is a flow diagram for an example procedure after loss of WLAN access PMIP S5/S8.

FIG. 21 is an example of the procedure used to resolve conflicts for WTRU initiated NBIFOM.

FIG. 22 is an example of the procedure used to result conflicts for NW-initiated NBIFOM.

FIG. 23 is an example of the TWAN rejecting network initiated NBIFOM due to loss of WLAN radio connectivity.

FIG. 24 is an example of the WTRU losing WLAN radio connectivity.

FIG. 25 is an example of RAN assistance information for a network-initiated NBIFOM trigger to move IP flows to 3GPP access.

FIG. 26 is an example of RAN assistance information for a network-initiated NBIFOM trigger to move IP flows to WLAN access.

FIG. 27 is an example of RAN initiated traffic steering.

FIG. 28 is an example of RAN initiated traffic steering.

FIG. 29 is an example of RAN assisted NBIFOM by providing RAN assistance information to the PGW.

FIG. 30 is an example of RAN assisted NBIFOM by providing RAN assistance information to the PCRF.

### DETAILED DESCRIPTION

A detailed description of illustrative embodiments will now be described with reference to the various Figures. Although this description provides a detailed example of possible implementations, it should be noted that the details are intended to be examples and in no way limit the scope of the application. As used herein, the articles “a” and “an”, absent further qualification or characterization, may be understood to mean “one or more” or “at least one”, for example.

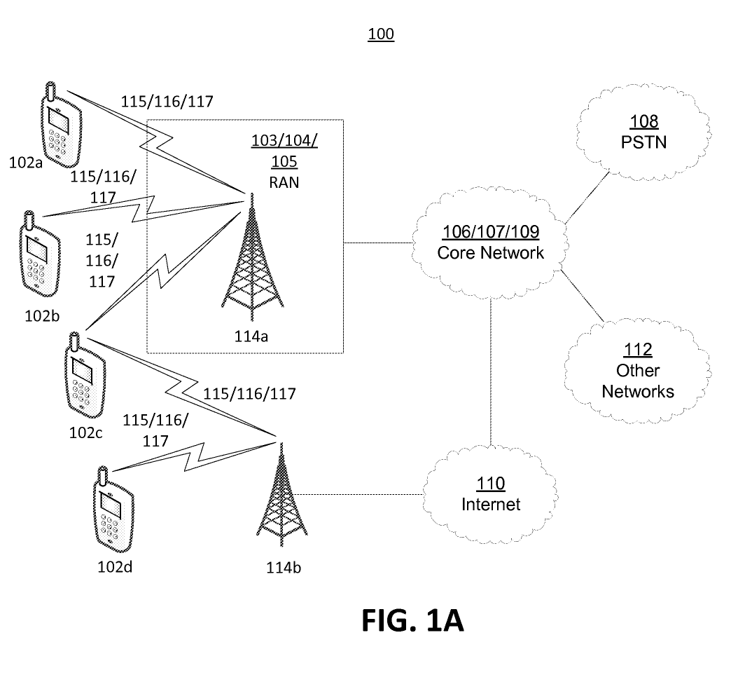

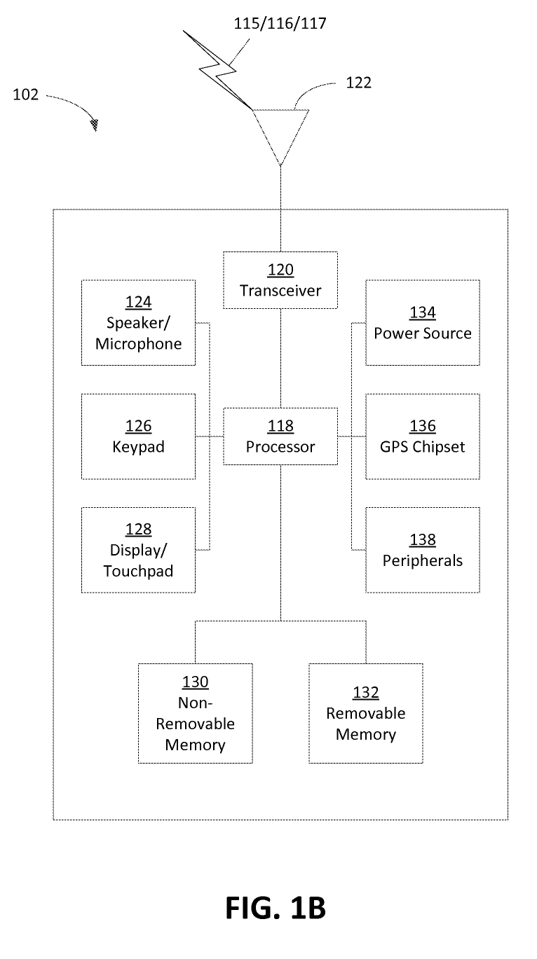

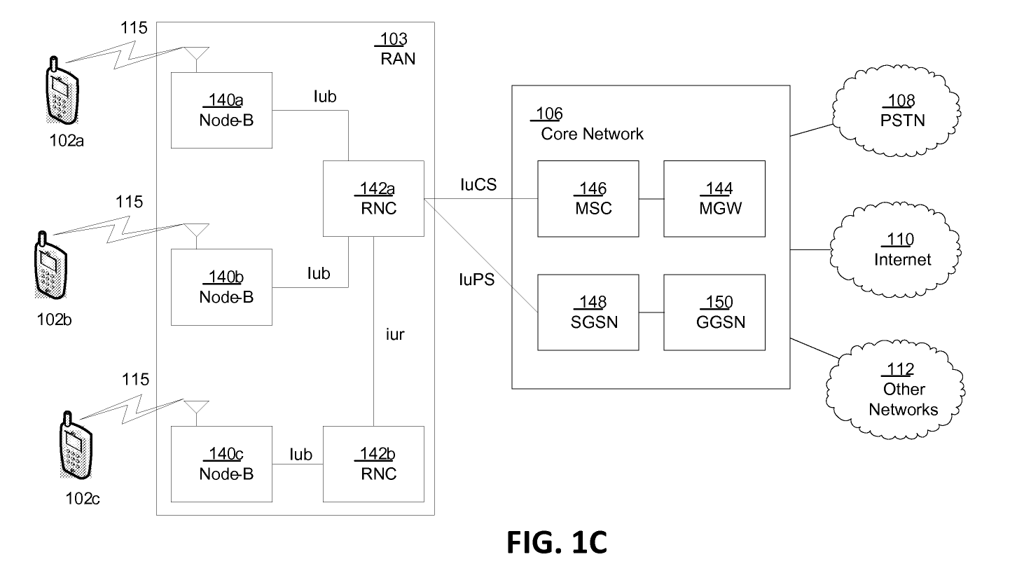

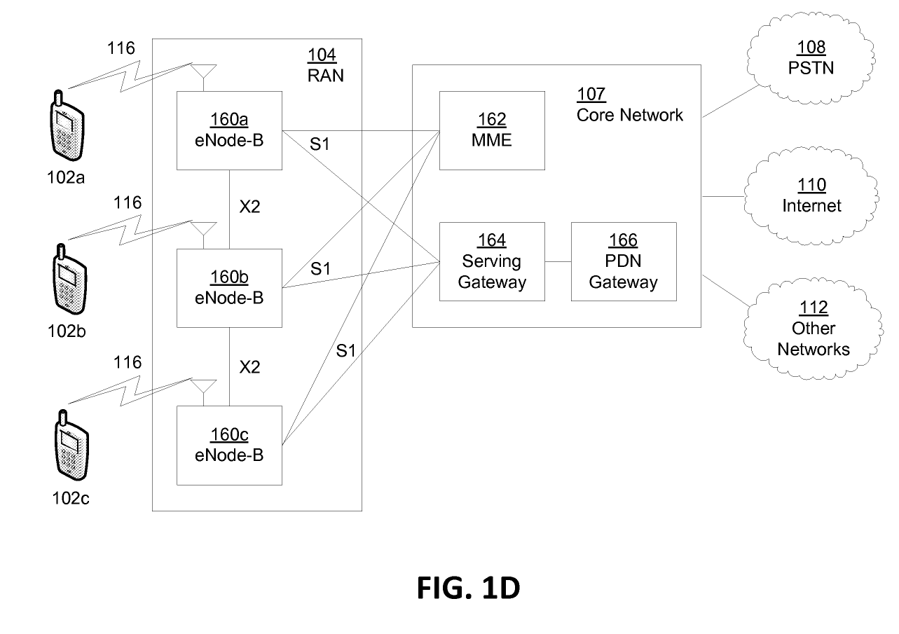

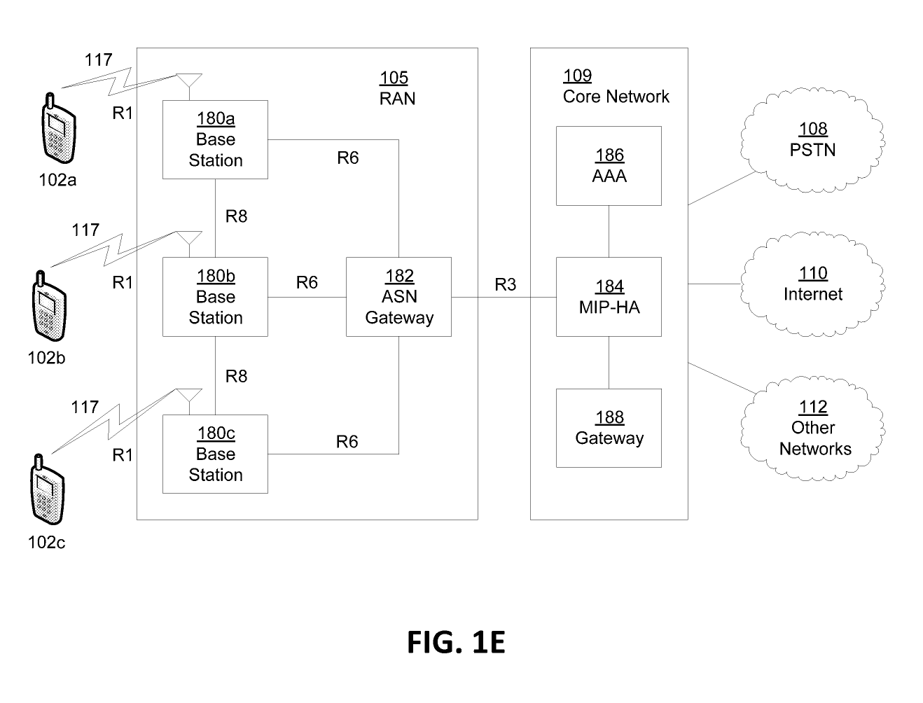

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. The WTRU may also be referred to as a user equipment (UE). Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro diversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

In order to support IP flow mobility (IFOM), a WTRU may be connected to the evolved packet system (EPS) via different access networks simultaneously (e.g., 3GPP and WLAN access) and may send and receive different IP flows through different access networks. IP flow mobility may be supported when IP flows are moved from one access (e.g., 3GPP access) to another access (e.g., WLAN access) while preserving the IP address. Seamless IFOM is defined to describe such IP flow mobility.

IP Flow Mobility (IFOM) for network-based Proxy Mobile IP (PMIP) and GPRS Tunneling Protocol (GTP)-based S2a and S2b over WLAN may be provided. A WTRU may support more than one radios. For example, the WTRU may support dual radio for 3GPP and WLAN access. The WTRU may support both the radios simultaneously. The usage of various radio access interfaces of a WTRU may depend on various conditions. In some cases it may be useful to move flows (e.g., IP flows) from one interface to another interface.

The demand for mobile network traffic has been increasing significantly. Offloading the traffic from the mobile network to other networks may offset the increasing demand. Many wireless transmit/receive units (WTRUs) are capable of multiple connections, for example, to a 3GPP access and/or a wireless local area network (WLAN).

Seamless offload and/or flow mobility, e.g., using network-based protocol, PMIP and/or GTP based S2a and S2b over WLAN may be provided using one or more of the following: the support of a PDN Connection active over one or more, or multiple, access networks simultaneously; the association of one or more IP flows belonging to a packet data network (PDN) connection to an access system; the movement of one or more IP flows belonging to a PDN connection between different access systems; the triggers for IP flow mobility in the WTRU and/or the network; WTRU-initiated and/or network-initiated network-based IP flow mobility (NB-IFOM); and/or the impact and/or the relationship to 3GPP related policies (e.g., Policy and Charging Control (PCC), Access Network Discovery and Selection Function (ANDSF), Inter System Routing Policy (ISRP), Inter-System Mobility Policy (ISMP), Radio Access Network (RAN) policy with no ANDSF etc.), if any, to support NB-IFOM.

Seamless IP flow Mobility may be provided. Seamless IP flow mobility may be provided, e.g., based on Dual Stack Mobile IP (DSMIP). A trigger to initiate IFOM and/or move an IP flow between access networks may be provided from the WTRU.

Seamless IP flow mobility may be based on DSMIP. The trigger to initiate IFOM and/or move an IP flow between access networks may be supported from the WTRU. For instance, WTRU-initiated IP flow mobility may be provided.

IP flow mobility may be provided, e.g., without requiring the WTRU and/or the network to support the DSMIP protocol. WTRU-initiated Network Based Flow Mobility may be provided in networks, e.g., supporting GTP and/or PMIP S2b reference points.

One or more routing rules may be provided via 3GPP access. For example, the routing rules may be sent by a WTRU to a serving gateway (SGW) via 3GPP access specific signaling (e.g., Non Access Stratum (NAS) signaling). During an attach (e.g., the initial attach), the WTRU may request PDN connectivity and/or a bearer resource modification procedure. The WTRU may provide a relative priority with one or more, or each, routing access type. The routing access type with the highest priority may be the default route. The WTRU may update the priority of a routing access type during IP flow mobility procedures. The gateway (e.g., PGW) may use the routing rule, for example, in order to evaluate in which access type to send downlink IP flow, among other reasons. Table 1 illustrates an example of a routing rule table. As illustrated in Table 1, the routing table may include routing rules, e.g., tied to flow IDs.

TABLE 1

| Routing | Routing | Routing | | | |
|---|---|---|---|---|---|
| Rule | Access | Access Type | | FID | |
| Name | Type | Priority | FID | Priority | Routing Filter |
| Rule | 3GPP | x | FID1 | a | Description of |
| Name1 | | | | | IP flows . . . |
| Rule | 3GPP | x | FID2 | b | Description of |
| Name 2 | | | | | IP flows . . . |
| Rule | WLAN | y | FID3 | c | Description of |
| Name 3 | | | | | IP flows . . . |

The one or more routing rules may be sent from the SGW to the PGW, e.g., via the GTP protocol for the GTP-based S5/S8. The SGW may include the routing rule in the Create session request message to the PGW. The PGW may install the routing rules to the Policy and Charging Rules Function (PCRF) and/or may acknowledge that the NB-IFOM is enabled to the WTRU. The routing rules may be sent from the SGW to PCRF and may be further sent to the PGW, e.g., via PCC protocol for the PMIP-based S5/S8. The SGW may include the routing rules in the Gateway Control Session establishment message and/or may acknowledge that the NB-IFOM is enabled to the WTRU. The PCRF may include the routing rules in the IP Connectivity Access Network (IP-CAN) session establishment acknowledge message to install the routing rule in the PGW. The NB-IFOM support may be negotiated during the initial attachment and WTRU requested PDN connectivity procedures.

Routing rules may be provided via WLAN access. For example, a WTRU may provide routing rules via WLAN access. The routing rules may be provided in at least one of the following ways. The routing rules may be provided, e.g., via Inter Key Exchange (IKEv2) Protocol from the WTRU to the ePDG, and/or via PMIPv6 or GTP-c signaling from the ePDG to the PGW.

This routing rule provided via WLAN access may be different than the routing rule provided via 3GPP access. The routing rule provided via WLAN may be negotiated between the WTRU and the PGW. The PGW may get the routing rule from the WTRU and/or may generate the binding cache with the routing address (e.g., MAG address). The routing rule may include one or more of: a Binding ID (BID), a BID priority, a Flow ID (FID), a FID priority, and/or a Routing filter. When the PGW receives the BID and/or FID mobility options, for example, among other scenarios, the PGW may copy the BID and/or the FID from the mobility mode to the corresponding field in the Binding Cache entry. For example of a typical Binding Cache in Local Mobility Anchor (LMA), e.g., PGW, with routing filters is shown in Table 2. One or more, or each BID/FID entry may contain a relative priority. Between WTRU and the LMA, for example, there may be a default routing address via which packets not matching any specific routing filter are routed. The BID with the highest priority may be the default route. Table 2 illustrates an example of a binding cache table, e.g., when sending routing rules over WLAN access.

TABLE 2

| | | Bind- | BID | | FID | |
|---|---|---|---|---|---|---|
| Home | Routing | ing | Pri- | Flow | Pri- | Routing |
| Address | Address | ID | ority | ID | ority | Filter |
| HoA1 | MAG | BID1 | x | FID1 | a | Description |
| | address1 | | | | | of IP |
| | | | | | | flows . . . |
| | | | | FID2 | b | Description |
| | | | | | | of IP |
| | | | | | | flows . . . |
| HoA1 | MAG | BID2 | y | FID3 | . . . | . . . |
| | address2 | | | | | |

To apply the IP flow mobility routing rule in 3GPP access, among other scenarios, the IP flow mobility routing rule may be sent to the PGW via 3GPP access. The routing rule may be sent to the PGW via WLAN access, e.g., to apply the IP flow mobility routing rule in WLAN.

The flow mobility may be implicitly triggered. The implicitly triggered flow mobility may be achieved through WTRU routing IP flows via WLAN or 3GPP access, perhaps for example without any signaling with the network.

The routing decisions in the WTRU may be driven by routing policies provided via the Access Network Discovery and Selection Function (ANDSF). The network may maintain a traffic mapping table which indicates the access on which the flows associated with a WTRU should be routed. The PGW may send the downlink data to the corresponding access gateway, e.g., when the network detects the movement of some flows from one access network to another.

In order to build the traffic mapping table, for example, among other reasons, the PGW may remember the destination address and/or port number of the latest uplink packets and/or may use the address and/or port number to create reverse routing rules. Using the reverse routing rules, downlink packets having the same IP address and/or port number in the source address and/or source port number fields may be forwarded via the same access (e.g., via the access on which the corresponding uplink IP packets were last seen).

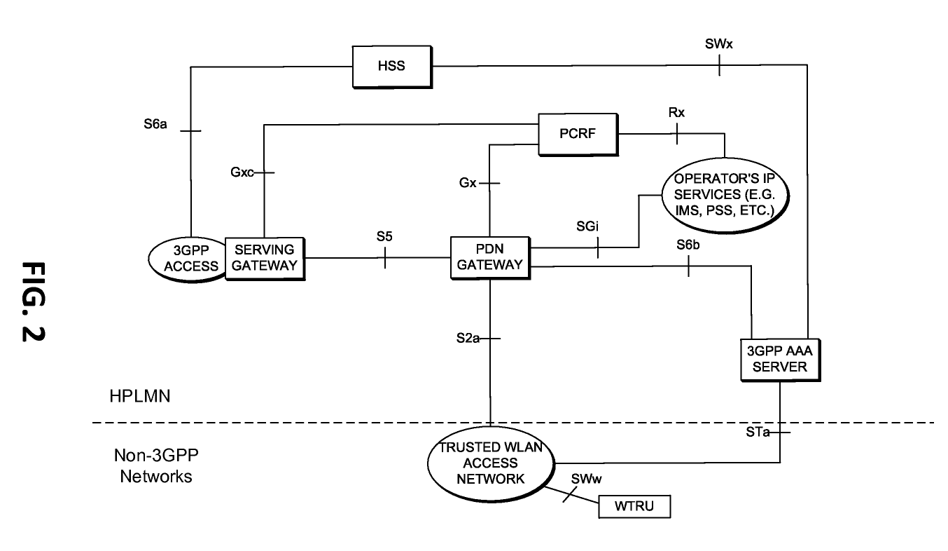

FIG. 2 illustrates an example of an S2a-based mobility over GTP (SaMOG) architecture. As illustrated in FIG. 2, when the WLAN is considered as trusted by the operator, the Trusted WLAN Access Network (TWAN) may be interfaced with the EPC as a trusted non-3GPP access via the STa interface to the 3GPP AAA Server/Proxy and/or the S2a interface to the PGW. For example, eSaMOG may be enhanced by allowing one or more of the following WTRU capabilities: control of adding/removing of a PDN connection, indication of Access Point Name (APN), indication of handover or new (e.g., fresh) attachment, and/or indication of NSWO or seamless offload.

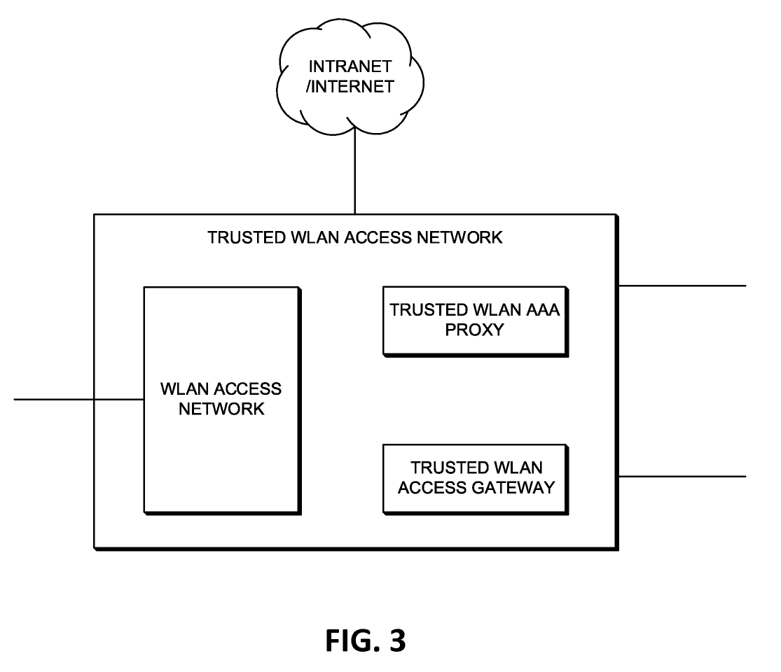

FIG. 3 illustrates an example of a Trusted WLAN Access Network Architecture. As illustrated in FIG. 3, the TWAN may include a Trusted WLAN AAA Proxy (TWAP) and/or a Trusted WLAN Access Gateway (TWAG). The TWAG may provide S2a connection (GTP or PMIP) towards PGW in 3GPP EPC. Also, the TWAP may forward user plane packets between the WTRU-TWAG point-to-point link corresponding to a specific PDN connection and/or the associated S2a tunnel for that WTRU. The TWAP may relay the AAA information between the WLAN Access Network and the 3GPP AAA Server or Proxy in case of roaming. The TWAP may provide the TWAG with WTRU subscription data during attach (e.g., initial attach) and/or at WTRU subscription data modification.

The network architecture may support one or more modes of operation. For example, there may be at least three modes of operations including, e.g., a WTRU supporting a Transparent Single-Connection mode, a WTRU supporting a Single-Connection mode, and/or a WTRU supporting multiple PDN connections over WLAN (Multi-Connection mode), etc.

A WTRU supporting a Transparent Single-Connection mode might not support IP address preservation during flow mobility or handover. A WTRU supporting a single-Connection mode may support Non-Seamless WLAN Offload (NSWO) and/or a single PDN connection (perhaps for example at a given time) over a Trusted WLAN. The WTRU supporting a Single-Connection mode might not require additional protocols than Extensible Authentication Protocol for Authentication and Key Agreement (EAP-AKA) in order to establish NSWO and/or PDN connectivity. A WTRU supporting multiple PDN connections over WLAN (Multi-Connection mode) may support simultaneous one or more PDN connections and/or may support NSWO over Trusted WLAN. A WTRU supporting Multi-Connection mode may use a specific protocol (e.g., WLCP), perhaps for example after the access authentication procedure to trigger PDN connection establishment or release.

Single-Connection and Multi-Connection modes may support IP address preservation between 3GPP and Trusted WLAN access and PDN connectivity to a non-default APN. A WTRU and the network may negotiate the mode of operation during authentication based on extensions to the EAP-AKA signaling between the WTRU and the network. The extensions for EAP-AKA in order to allow the WTRU and the network to negotiate mode of operation may be provided, among other scenarios.

The WTRU to network direction may use one of the two requested connection modes: a Single-Connection mode and/or a Multiple-Connection mode. The requested connectivity may be NSWO and/or a PDN connection, e.g., if a Single-Connection mode is requested. The PDN type (IPv4, IPv6, or IPv4v6) may be provided, e.g., if the requested connectivity is a PDN connection. A hand-over indicator, the requested APN, and/or a Protocol Configuration Options (PCO) may be provided. The requested APN may be used, e.g., if the handover indication is provided.

The network-to-WTRU direction may use one or more of the following modes: Transparent Single-Connection mode, Single Connection mode, and/or Multi Connection mode. The extension to the signaling may be whether the requested connectivity (e.g., NSWO or a PDN connection) has been granted, e.g., if the Single-Connection mode is requested. For the PDN connection, the extension may include selected APN, and/or the selected PDN type (e.g., IPv4, IPv6, or IPv4v6). The extension may include Protocol Configuration Options (PCO). The extension to the signaling may be whether NSWO is allowed or not, e.g., if a Multi-Connection mode is requested.

For a WTRU supporting a Multi-Connection mode over an S2a Mobility based on GTP (SaMOG) WLAN, the WTRU and/or the TWAN may use the WLAN Control Protocol (WLCP) protocol as a control layer. The WTRU and/or the TWAN may use the WLCP protocol to enable management of PDN connectivity over a Trusted WLAN Access Network.

WLCP may provide session management. The session management may be provided for one or more of establishment of PDN connections, handover (e.g., from a 3GPP access) of PDN connections, request the release of a PDN connection by the WTRU, notify the WTRU of the release of a PDN connection, and/or IP address assignment (e.g., delivery of the IPv4 address through WLCP).

The ANDSF and/or RAN techniques for traffic steering from WLAN may be provided. The ANDSF may be a functional entity that may interface with the WTRU over IP, e.g., via the S14 reference point. The ANDSF may allow the WTRU to be informed of criteria, e.g., to select WLAN access and/or conditions to steer traffic to/from WLAN. The ANDSF may provide policies to the WTRU including criteria and/or conditions for the WTRU to select WLAN access and/or perform traffic steering to and from WLAN access.

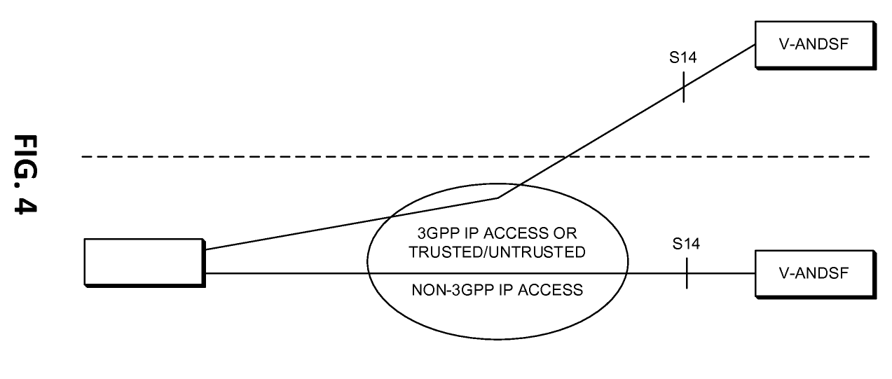

FIG. 4 illustrates an example ANDSF architecture. Similar functionality may be supported by the RAN (e.g., eNB), e.g., where the eNB may provide RAN Assistance Information to the WTRU including WLAN identifiers and/or thresholds (e.g., RAN RSPR min/max, or WLAN Basic Service Set (BSS) load) that may be indicators (e.g., conditions) for the WTRU to steer traffic to WLAN.

For a WTRU having simultaneous connection to both a 3GPP access and a Release SaMOG WLAN, the WTRU may support seamless IP flow mobility between the 3GPP and SaMOG WLAN access. Systems, methods, and/or instrumentalities may be provided for WTRU-initiated triggered IP Flow Mobility and/or NW-initiated triggered IP flow mobility for WTRUs connected to a SaMOG WLAN, e.g., using as a Single-Connection mode and/or a Multi-Connection mode, etc.

A simultaneous support of a PDN connection over 3GPP access and WLAN access may be provided. For example, in case of NB-IFOM, a WTRU may establish and/or maintain a PDN connection over 3GPP access and WLAN access. The PDN connection may be maintained simultaneously. The support of a PDN connection may be provided in case of S2b and/or S2a connectivity.

The communication between the WTRU and the PGW may be provided, e.g., to install the one or more routing rules. For NB-IFOM, there may be no direct communication support between the WTRU and the PGW to install the one or more routing rules. NB-IFOM may be WTRU-initiated and/or network-initiated. For a WTRU-initiated NB-IFOM, a WTRU may provide the PGW with the desired mapping between IP flows and access links. The network may accept or reject a WTRU's request for IP flow mobility, but might not initiate IP flow mobility itself. For a Network-initiated NB-IFOM, the PGW may provide the WTRU with the desired mapping between IP flows and access links. The WTRU may accept or reject the network's request for IP flow mobility (e.g., based on the suitability of the WLAN link conditions), but might not initiate IP flow mobility itself.

Multiple IP interfaces may be provided with similar IP addresses. The assignment of IPv4 address, IPv6 prefix(es) and/or IPv6 interface identifiers, handling of multicast packets, including signaling messages that may be sent on a multicast link-local address (e.g., DHCPv6, RA/RS), etc. may be analyzed.

Loss of WLAN access may be encountered. For a WTRU with active flows on both WLAN access and 3GPP access, if the WLAN coverage is lost, a mechanism may be useful to move the Service data Flows back to 3GPP access, perhaps for example in order to minimize service disruption, among other reasons.

NB-IFOM capability discovery may be useful. It may be possible for a WTRU and a network to discover whether the network and/or the WTRU respectively support NB-IFOM.

Conflict resolution between WTRU-initiated and network-initiated NB-IFOM may be useful. The conflict resolution may be used to avoid the application of both WTRU initiated and network initiated NB-IFOM to a PDN connection that may lead to conflicts.

Support for RAN-initiated Network Based Flow Mobility for network supporting a GTP or PMIP S2b reference point may be useful. The RAN may be an eNodeB and/or an RNC. The traffic offload may be provided at the granularity of IP flow, bearer level, PDN connection level, and/or APN level.

Systems, methods and/or instrumentalities may be provided to implement trigger flow mobility and/or to provide routing rules. IFOM for WTRUs supporting a single-connection mode may be provided. A WTRU-initiated NBIFOM for WTRUs supporting a single PDN connection over WLAN may be provided.

A WTRU may obtain one or more routing rules from the ANDSF and/or based on a trigger from the RAN using RAN assistance information. One or more routing rules may include one or more of a Home Address (WTRU IP address), a Routing Address (e.g., a MAG address), a Flow ID, a Flow ID priority, and/or a description of IP flows.

When the PGW receives routing rule information from the WTRU, for example, among other scenarios, the PGW may generate a binding cache table with the routing address (e.g., MAG address). The PGW may send the downlink data of IP flows to the corresponding access gateway, e.g., based on the binding cache information.

A WTRU may send routing rules via WLAN access, e.g., by using EAP/AKA′ signaling between WTRU and TWAN. For a WTRU that has negotiated a Single-Connection mode, for example, among other scenarios, perhaps in order to support IFOM, the WTRU may provide routing rules using EAP-AKA′ signaling. The TWAN may inspect EAP-AKA′ signaling and/or may forward the routing rules to the PGW over GTP/PMIP S2a. The EAP-AKA′ may be extended to support the WTRU including routing rules within EAP-AKA′ signaling.

A WTRU may initiate an EAP-AKA request to the server. For example, the WTRU may send an IEEE 802.1X EAP over LAN (EAPOL) Start message to the authenticator, perhaps for example in order for the authenticator to respond with an EAP-Request command, among other reasons.

The EAP signaling may be extended to allow the WTRU to initiate signaling to the authentication server. For example, a WTRU may be authenticated and may trigger the authenticator with signaling for re-authentication. The WTRU may provide notifications. The server may initiate EAP notification requests to the peer.

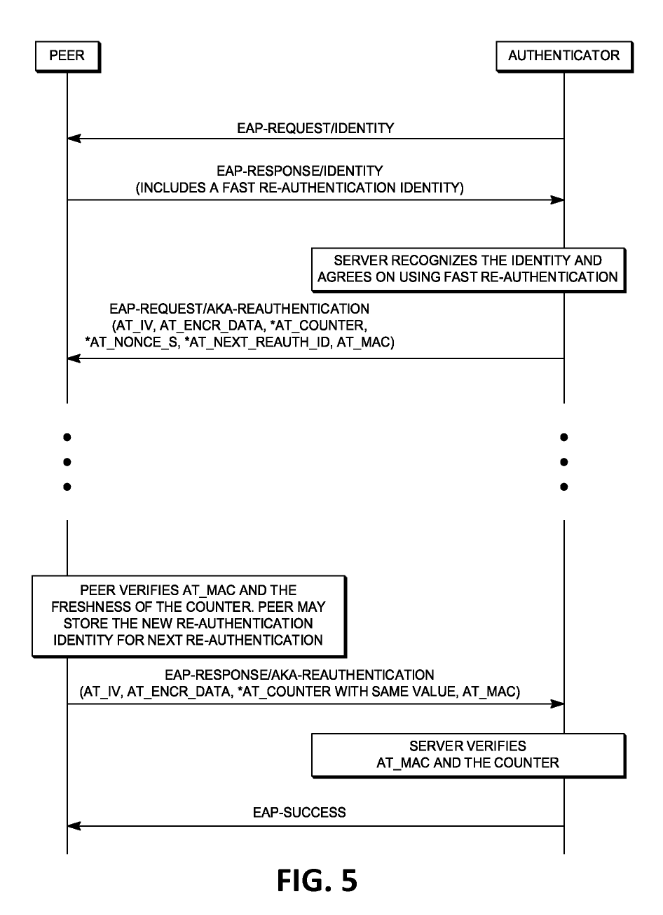

The fast re-authentication may be reused. FIG. 5 illustrates an example of server requests for peer re-authentication at particular time intervals in the fast re-authentication approach. In a fast re-authentication response, the WTRU may include routing rules in notification response messages.

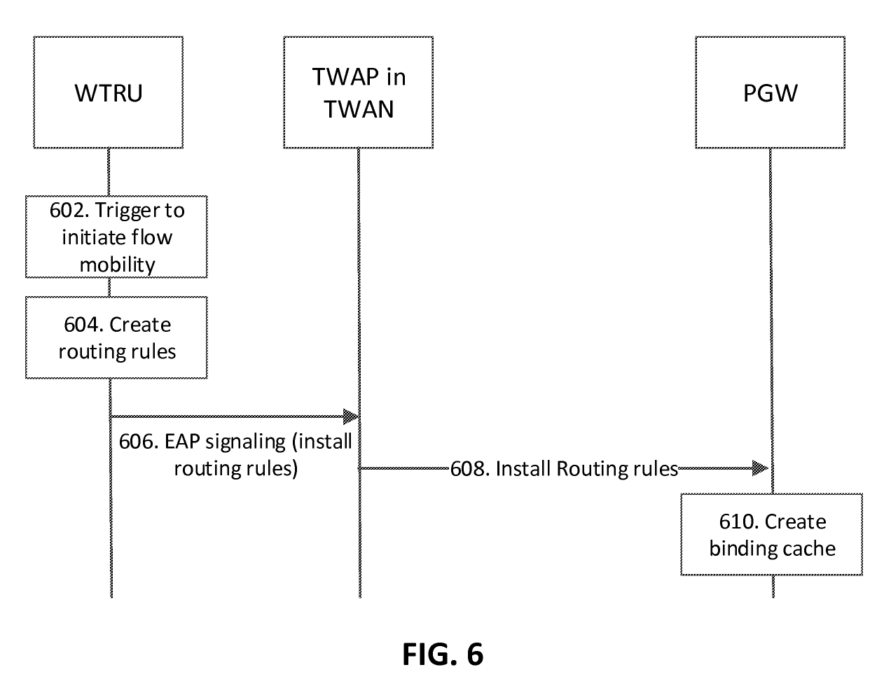

FIG. 6 illustrates an example of a WTRU-initiated IFOM for a Single Connection mode, e.g., using EAP signaling. As illustrated in FIG. 6, at 602, the WTRU may receive and/or determine a trigger to initiate NB-IFOM to WLAN access, e.g., either via an ANDSF policy and/or a RAN rule—not shown. At 604, the WTRU may create routing rules based on the trigger. During EAP authentication, the WTRU may include the routing rules for WTRU-initiated NB-IFOM. At 606, the WTRU may send routing rules via EAP-signaling (e.g., modified EAP-signaling). The EAP-signaling may be WTRU initiated EAP-notification. The WTRU may include a flag indicating that routing rules are sent in order to allow the TWAP.

As illustrated in FIG. 6, the TWAP (e.g., within a TWAN) may detect the flag that the EAP signaling might not be proxied to the Authentication, Authorization, and Accounting (AAA) server. The TWAP within the TWAN may extract the routing rules from EAP-AKA′ signaling. At 608, the TWAN may forward the routing rules within the Create Session request (e.g., if NB-IFOM requires a new PDN connection over WLAN) or Modify Bearer Command or Modify Bearer Request signaling (e.g., if NB-IFOM is made on an existing PDN connection) via GTP S2a towards the PGW (e.g., if PMIP S2a is used the routing rules are sent within a Proxy Binding Update.

At 610, the PGW may generate a binding cache table with the routing address (e.g., MAG address), e.g., when the PGW receives routing rule information from the WTRU. The PGW may send the downlink data of IP flows to the corresponding access gateway based on the binding cache information.

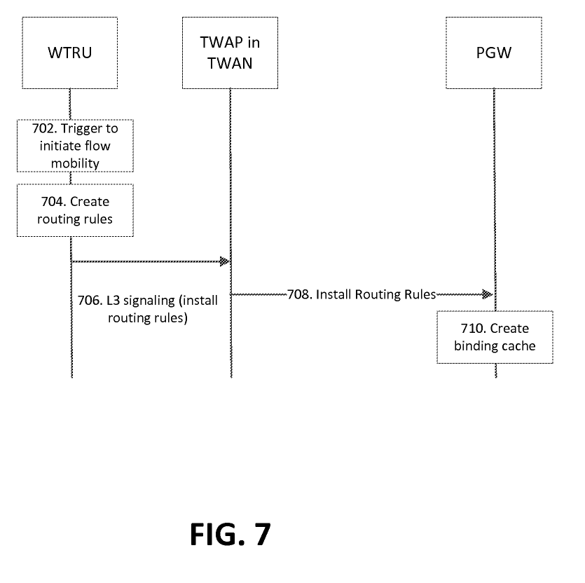

FIG. 7 illustrates an example of a WTRU-initiated IFOM for a Single Connection mode, e.g., using L3 signaling. As illustrated in FIG. 7, the WTRU may send routing rules via WLAN access, e.g., using L3 messages (e.g., DHCPv4 and/or IPv6 RS/RA signaling) between WTRU and TWAN. The WTRU may send routing rules, e.g., using DHCPv4 and/or DHCPv6 signaling. Enhancements within DHCPv4/v6 signaling may be made in order to convey the routing rules. For example, one method to enhance DHCPv4/v6 may be to provide routing rules within DHCP OPTIONS field for either UE-initiated or NW-initiated NBIFOM. The TWAN may forward the routing rules to the PGW within the Create Session request (e.g., if NBIFOM requires a new PDN connection over WLAN) or Modify Bearer Command or Modify Bearer Request message (e.g., if NBIFOM is made on an existing PDN connection), e.g., if GTP S2a is used between the TWAN and the PGW. The TWAN may forward the routing rules within a Proxy Binding Update message, e.g., if PMIP S2a is used between the TWAN and the PGW.

As illustrated in FIG. 7, at 702, the WTRU may receive a trigger to initiate NB-IFOM to WLAN access, for example, either via an ANDSF policy or a RAN rule. At 704, the WTRU may create routing rules based on the trigger received. At 706, the WTRU may send the routing rules within DHCPv4 or DHCPv6 signaling.

At 708, the TWAN may forward the routing rules within the Create Session request (e.g., if NB-IFOM requires a new PDN connection over WLAN) or Modify Bearer Command or Modify Bearer Request signaling (e.g., if NB-IFOM is made on an existing PDN connection), e.g., if GTP S2a is used between the TWAN and the PGW. The routing rules may be sent within a Proxy Binding Update, e.g., if PMIP S2a is used between the TWAN and the PGW.

At 710, the PGW may generate a binding cache table with the routing address (e.g., MAG address), e.g., when the PGW receives routing rule information from the WTRU. The PGW may send the downlink data of IP flows to the corresponding access gateway based on the binding cache information.

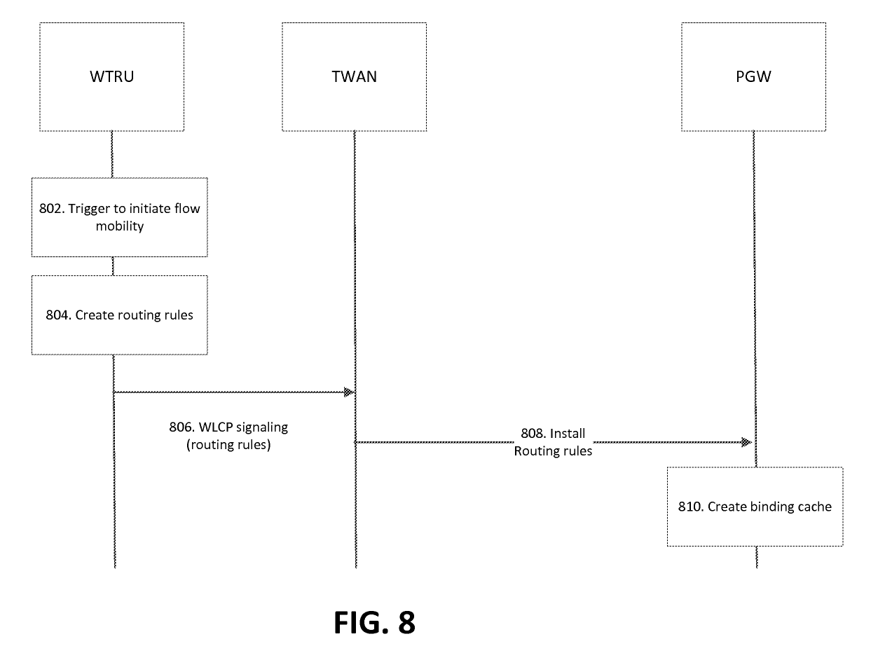

FIG. 8 illustrates an example of a WTRU-initiated NB-IFOM for a Single Connection mode, e.g., via WLCP signaling. As illustrated in FIG. 8, the WTRU may send routing rules via WLAN access e.g., by introducing WLCP protocol to the WTRUs supporting single PDN connection between WTRU and TWAN. The WLCP protocol may be supported for the WTRU supporting establishment of multiple PDN connections over WLAN. The WLCP protocol to WTRUs supporting single PDN connections over SaMOG WLAN (e.g., WTRUs supporting a Single Connection mode) may be provided.

As illustrated in FIG. 8, at 802, the WTRU may receive a trigger to initiate NB-IFOM to WLAN access (e.g., via an ANDSF policy or a RAN rule). At 804, the WTRU may create routing rules to move IP flows from 3GPP to WLAN taking into account the information provided, e.g., by the ANDSF rule (e.g., IP flows, APN information) or the RAN rules. At 806, the WTRU may include the routing rule within WLCP signaling towards a TWAN. The WTRU may include APN information for the PDN connection where the IP flows may be moved.

At 808, the TWAN may determine the PDN connection to forward the routing rules and may send the routing rules to the PGW, for example, via an S2a reference point. The routing rules may be sent within the Create Session request or Modify Bearer Command or Modify Bearer Request signaling, e.g., if GTP S2a is used between the TWAN and the PGW. The Create Session request may be used, e.g., if NB-IFOM requires a new PDN connection over WLAN, and Modify Bearer Command or Modify Bearer Request signaling may be used, e.g., if NB-IFOM is made on an existing PDN connection. The routing rules may be sent within a Proxy Binding Update message, e.g., if PMIP S2a is used between the TWAN and the PGW.

At 810, the PGW may generate the binding cache with the routing address (e.g., MAG address). Based on the binding cache, the PGW may send the downlink data to the corresponding access gateway. The routing rules may be sent from the PGW to the WTRU via 3GPP access signaling (e.g., NAS), e.g., if the routing rules are provided via 3GPP access (for IP flows to be moved to the 3GPP access).

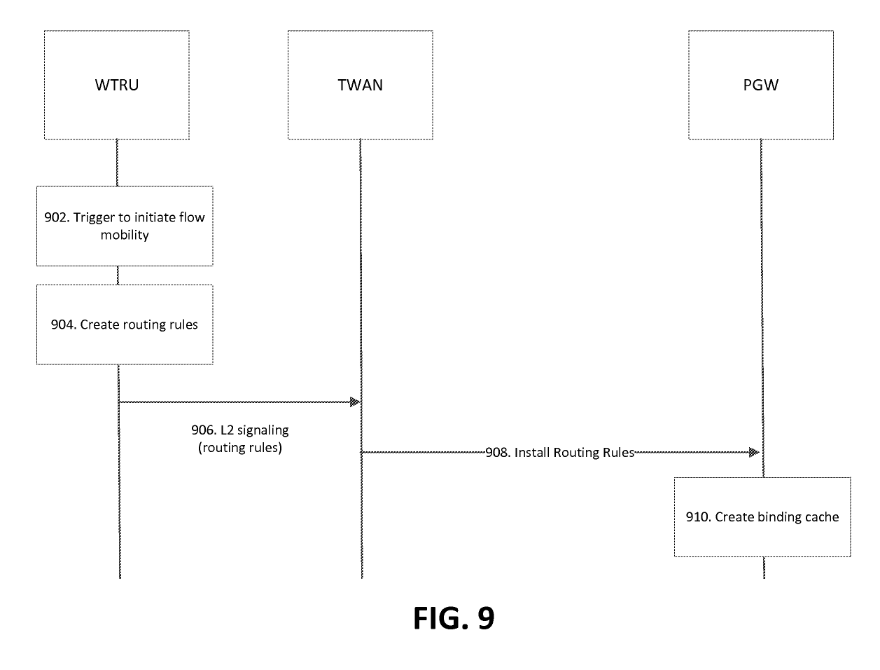

FIG. 9 illustrates an example of WTRU-initiated NB-IFOM for a Single Connection mode, e.g., via L2 signaling. A WTRU may send routing rules, e.g., via WLAN access within Layer 2 based signaling (e.g., MAC frames) between the WTRU and the TWAN. Sending the routing rules may require changes to layer 2 signaling between the WTRU and the TWAN where IEEE 802.11 procedures are used. For example, routing rules may be inserted within an Ethertype. An example description of Ehtertype is provided, e.g., by IEEE within MAC frames.

As illustrated in FIG. 9, at 902, the WTRU may receive a trigger to initiate NB-IFOM to WLAN access (e.g., via an ANDSF policy or a RAN rule). At 904, the WTRU may create a routing rule to move IP flows from 3GPP to WLAN taking into account the information provided by the ANDSF rule (e.g., IP flows, APN information) or the RAN rules. At 906, the WTRU may include the routing rule within layer 2 IEEE 802.11 signaling towards a TWAN. The WTRU may include APN information for the PDN connection where the IP flows may be moved.

At 908, the TWAN may determine the PDN connection to forward the routing rules and may send the routing rules to the PGW via an S2a reference point. The routing rules may be sent within the Create Session request (e.g., if NB-IFOM requires a new PDN connection over WLAN) or Modify Bearer Command or Modify Bearer Request signaling (e.g., if NB-IFOM is made on an existing PDN connection), e.g., if GTP S2a is used between the TWAN and the PGW. The routing rules may be sent within a Proxy Binding Update message, e.g., if PMIP S2a is used between the TWAN and the PGW.

At 910, the PGW may generate the binding cache with the routing address (e.g., MAG address). Based on the binding cache, the PGW may send the downlink data to the corresponding access gateway. The routing rule may be sent from the PGW to the WTRU, e.g., via 3GPP access signaling (e.g., NAS), e.g., if the routing rule is provided via 3GPP access (for IP flows to be moved to the 3GPP access).

A network may initiate NB-IFOM for WTRUs supporting a single PDN connection over WLAN. A PGW may provide the routing rules towards a TWAN, e.g., if routing rules are provided, e.g., via WLAN access. These routing rules may be provided based on a trigger from the PCRF. The PGW may obtain routing rule information from the PCRF over a Gx reference point, e.g., based on routing policies installed at the PCRF. The PCRF may decide to initiate flow mobility based on RAN congestion status by the RCAF, application detection by the TDF, usage monitoring events by the PCEF, and/or user spending limit reports, for example.

The WTRU may create a binding cache based on the routing rule and/or may forward uplink data of the same IP flow over the corresponding access gateway. The WTRU may use Logical Interface functionality (LIF) to support IFOM.

A TWAN may send routing rules via WLAN access, e.g., via EAP/AKA′ signaling between TWAN and WTRU. For network-initiated NB-IFOM, EAP signaling may be used, for example, as the EAP signaling is initiated from the authenticator (TWAN). The TWAN may send routing rules within EAP-Notification signaling. The EAP-Notification messages may be extended in order to convey routing rules.

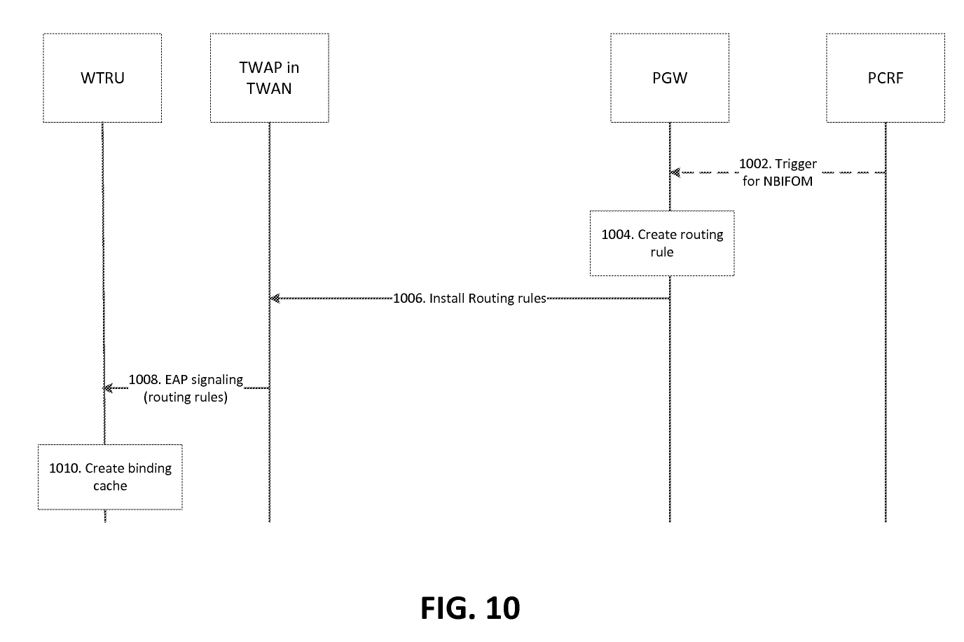

FIG. 10 illustrates an example of NW-initiated IFOM for a Single Connection mode via a WLAN access point, e.g., using EAP signaling for sending routing rules. As illustrated in FIG. 10, at 1002, PCRF may provide a trigger to a PGW, e.g., via a Gx reference point to change an IP flow via particular access (e.g., WLAN or 3GPP). This trigger may be based on a PCC trigger from subscription information, packet inspection, e.g., via TDF, usage monitoring, and/or congestion information from RAN. The PCRF may provide the routing rules to the PGW.

The PGW may decide to trigger network-initiated NB-IFOM, for example, based on a trigger by the PCRF and/or static configuration. At 1004, the PGW may create a routing rule for the IP flows to be moved to different access. At 1006, the PGW may include the routing rules in a message toward a TWAN. The routing rules may be provided, e.g., within an Update Bearer Request via GTP S2a (if GTP S2a is used between the TWAN and the PGW). The PGW may provide the routing rules within a Flow Mobility Initiate (FMI) message, e.g., if PMIP S2a is used.

The PCRF may provide the routing rules directly to the TWAN, e.g., via a Gxx reference point using PCC procedures. In such a case, the TWAN may use an interface towards the PCRF.

At 1008, the TWAN may determine based on the routing rule on which APN the flow mobility applies and may send the routing rules, e.g., via EAP-signaling to the WTRU. The TWAP in the TWAN may send the routing rule within EAP-notification messages.

At 1010, the WTRU may create a binding cache based on the routing rule and may forward uplink data of the same IP flow over the corresponding access gateway. The WTRU may use Logical Interface functionality (LIF).

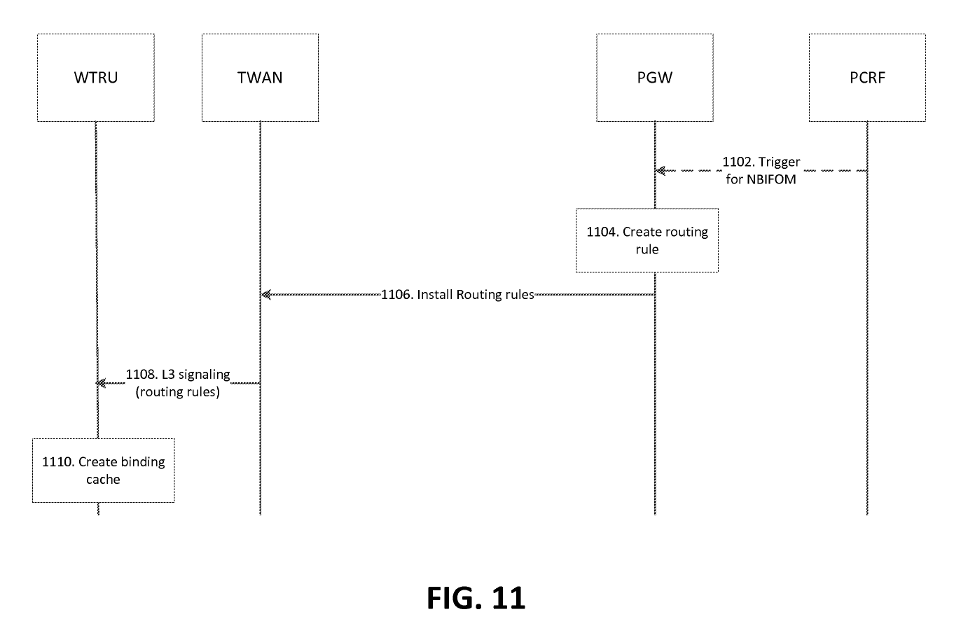

FIG. 11 illustrates an example of NW-initiated IFOM for a Single Connection mode via a WLAN access point using L3 messages. As illustrated in FIG. 11, a TWAN may send routing rules, e.g., via WLAN access within L3 messages (e.g., DHCPv4 or IPv6 RS/RA signaling) between TWAN and WTRU. When the TWAN receives the routing rules from a PGW, for example, among other scenarios, the TWAN may forward the routing rules via layer 3 signaling, e.g., DHCPv4 or v6 signaling to the WTRU. The routing rules may be sent within the DHCP OPTIONS field within DHCPv4/v6 signaling.

As illustrated in FIG. 11, at 1102 PCRF may provide a trigger to the PGW via for example a Gx reference point to change an IP flow via particular access (e.g., WLAN or 3GPP). This trigger may be based on a PCC trigger from subscription information, packet inspection via TDF, usage monitoring, or congestion information from RAN. The PCRF may provide the routing rules to the PGW.

The PGW may decide to trigger network-initiated NB-IFOM, for example, based on a trigger by the PCRF and/or static configuration. At 1104, the PGW may create a routing rule for the IP flows to be moved to different access. At 1106, the PGW may include the routing rule in a message towards a TWAN. The routing rules may be provided within an Update Bearer Request via GTP S2a. The PGW may provide the routing rule within a Flow Mobility Initiate (FMI) message, e.g., if PMIP S2a is used.

The PCRF may provide the routing rules directly to the TWAN, e.g., via a Gxx reference point using PCC procedures. In such scenarios, among others, the TWAN may use an interface towards the PCRF.

At 1108, the TWAN may determine based on the routing rule on which APN the flow mobility applies and/or may send the routing rules, e.g., via Layer 3 signaling (DHCPv4 or DHCPv6 to the WTRU. The TWAN may include the routing rules and APN information.

At 1110, the WTRU may create a binding cache based on the routing rule and/or may forward uplink data of the same IP flow over the corresponding access gateway. The WTRU may use Logical Interface functionality (LIF), e.g., to support IFOM.

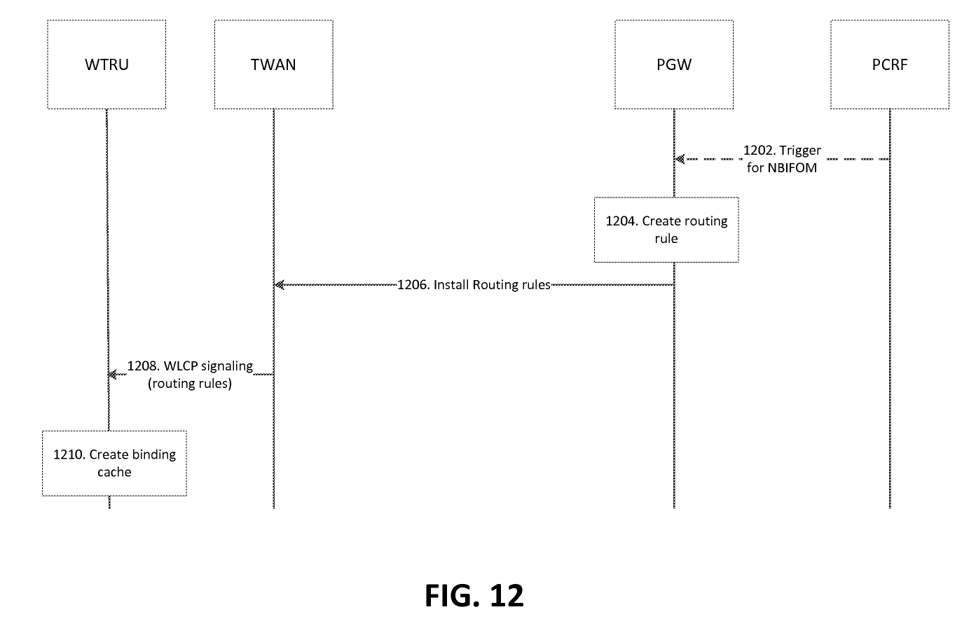

FIG. 12 illustrates an example of NW-initiated IFOM for a Single Connection mode via a WLAN access point using WLCP protocol. As illustrated in FIG. 12, a TWAN may send routing rules via WLAN access, e.g., by introducing WLCP protocol to WTRUs supporting single PDN connection between TWAN and WTRU. The TWAN may forward the routing rule via WLCP signaling to the WTRU, e.g., when the TWAN receives the routing rules from the PGW.

As illustrated in FIG. 12, at 1202, the PCRF may provide a trigger to the PGW via a Gx reference point to change an IP flow via particular access (e.g., WLAN or 3GPP). This trigger may be based on a PCC trigger from subscription information, packet inspection via TDF, usage monitoring, and/or congestion information from RAN. The PCRF may provide the routing rules to the PGW.

The PGW may decide to trigger network-initiated NB-IFOM, for example, based on a trigger by the PCRF and/or static configuration. At 1204, the PGW may create one or more routing rules for the one or more IP flows to be moved to different access. At 1206, the PGW may include the one or more routing rules in a message towards a TWAN. The one or more routing rules may be provided within an Update Bearer Request via GTP S2a. The PGW may provide the one or more routing rule within a Flow Mobility Initiate (FMI) message, e.g., if PMIP S2a is used.

The PCRF may provide the one or more routing rules directly to the TWAN via a Gxx reference point using PCC procedures. In such scenarios, among others, the TWAN may require an interface towards the PCRF.

At 1208, the TWAN may determine based on the one or more routing rules on which APN the flow mobility applies and/or may send the one or more routing rules, e.g., via WLCP signaling to the WTRU. The TWAN may include the one or more routing rules and/or APN information. The one or more routing rules and/or APN information may be included in a NBIFOM request. At 1210, the WTRU may create a binding cache based on the one or more routing rules and/or may forward uplink data of the same IP flow over the corresponding access gateway. The WTRU may use Logical Interface functionality (LIF) to support IFOM.

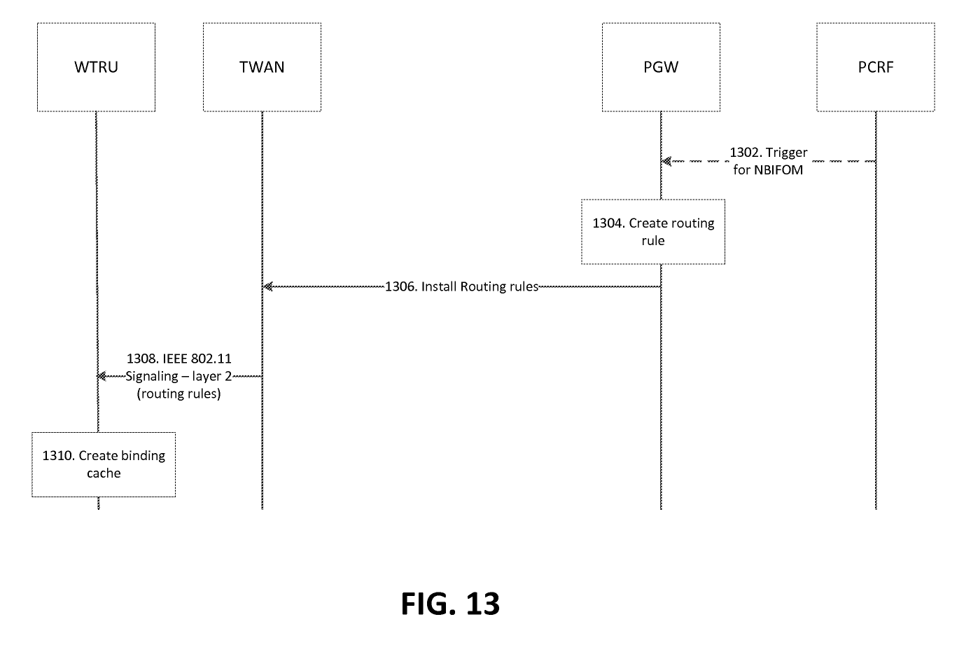

FIG. 13 illustrates an example of NW-initiated IFOM for a Single Connection mode via WLAN access point, e.g., using layer 2 based signaling. As illustrated in FIG. 13, a TWAN may send one or more routing rules via WLAN access within layer 2 based signaling between TWAN and WTRU. When the TWAN receives the one or more routing rules from a PGW, for example. Among other scenarios, the TWAN may forward the one or more routing rules via layer 2 IEEE 802.11 signaling to the WTRU.

As illustrated in FIG. 13, at 1302, the PCRF may provide a trigger to the PGW via a Gx reference point to change an IP flow via particular access (e.g., WLAN or 3GPP). This trigger may be based on, for example, a PCC trigger from subscription information, packet inspection via TDF, usage monitoring, and/or congestion information from RAN. The PCRF may provide the one or more routing rules to the PGW.

The PGW may decide to trigger network-initiated NB-IFOM, for example, based on a trigger by the PCRF and/or static configuration. At 1304, the PGW may create one or more routing rules for the IP flows to be moved to different access. At 1306, the PGW may include the routing rule in a message towards a TWAN. The one or more routing rules may be provided within an Update Bearer Request if GTP S2a is used between the PGW and the TWAN. The PGW may provide the one or more routing rules within a Flow Mobility Initiate (FMI) message, e.g., if PMIP S2a is used between the PGW and the TWAN.

The PCRF may provide the one or more routing rules directly to the TWAN, e.g., via a Gxx reference point using PCC procedures. In such scenarios, among others, the TWAN may use an interface towards the PCRF.

At 1308, the TWAN may determine based on the one or more routing rules on which APN the flow mobility applies and/or may send the one or more routing rules, e.g., via IEEE 802.11 signaling or Layer 2-based signaling to the WTRU. The TWAN may include the one or more routing rules and APN information.

At 1310, the WTRU may create a binding cache based on the one or more routing rules and may forward uplink data of the same IP flow over the corresponding access gateway. The WTRU may use Logical Interface functionality (LIF) to support IFOM.

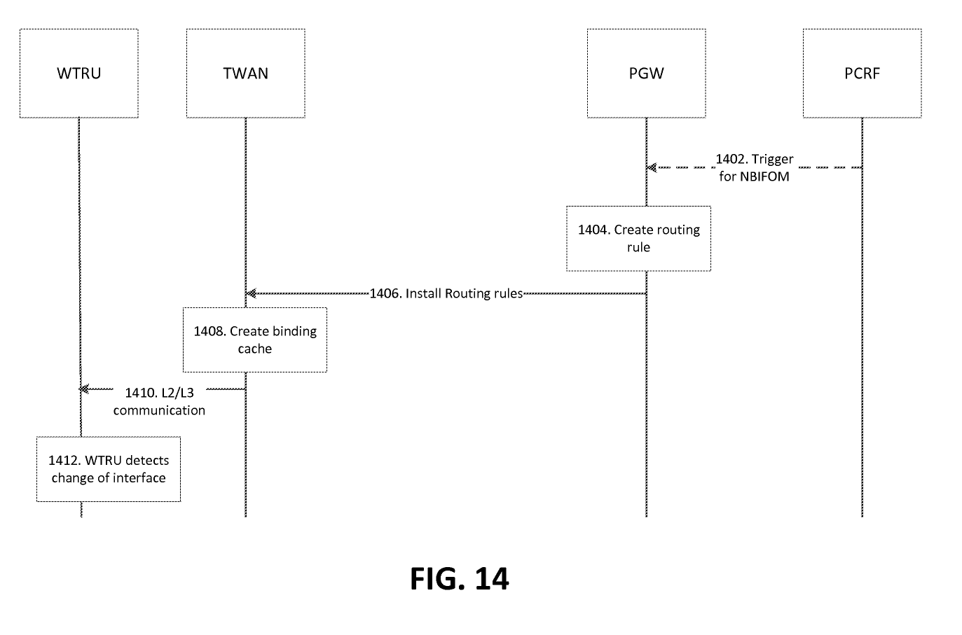

A TWAN may implement the one or more routing rules and may ensure the IP flows on the downlink are sent to the appropriate PDN connection. FIG. 14 illustrates an example of NW-initiated IFOM for a Single Connection mode via a WLAN access point using an L2/L3 communication.

As illustrated in FIG. 14, at 1402, the PCRF may provide a trigger to the PGW via a Gx reference point to change an IP flow via particular access (e.g., WLAN or 3GPP). This trigger may be based on, for example, a PCC trigger from subscription information, packet inspection via TDF, usage monitoring, and/or congestion information from RAN. The PCRF may provide the one or more routing rules to the PGW.

The PGW may decide to trigger network-initiated NB-IFOM, for example, based on a trigger by the PCRF and/or static configuration. At 1404, the PGW may create one or more routing rules for the one or more IP flows to be moved to different access. At 1406, the PGW may include the one or more routing rules in a message towards a TWAN. The one or more routing rules may be provided within an Update Bearer Request, perhaps for example if GTP S2a is used between the PGW and the TWAN, among other scenarios. The PGW may provide the one or more routing rules within a Flow Mobility Initiate (FMI) message, e.g., if PMIP S2a is used between the PGW and the TWAN, among other scenarios.

The PCRF may provide the one or more routing rules directly to the TWAN via a Gxx reference point using PCC procedures. In such a case, the TWAN may require an interface towards the PCRF.

At 1408, the TWAN may create a binding cache based on the one or more routing rules and/or may forward the IP flows, e.g., to the appropriate Layer 3 communication to the WTRU. At 1410, Layer 3/2 communication (e.g., normal Layer 2/3 communication) between WTRU and TWAN may provide IP flows. At 1412, the WTRU may detect that certain IP flows have been changed to a different interface and/or may ensure that the same IP flows are sent on the same interface in the uplink.

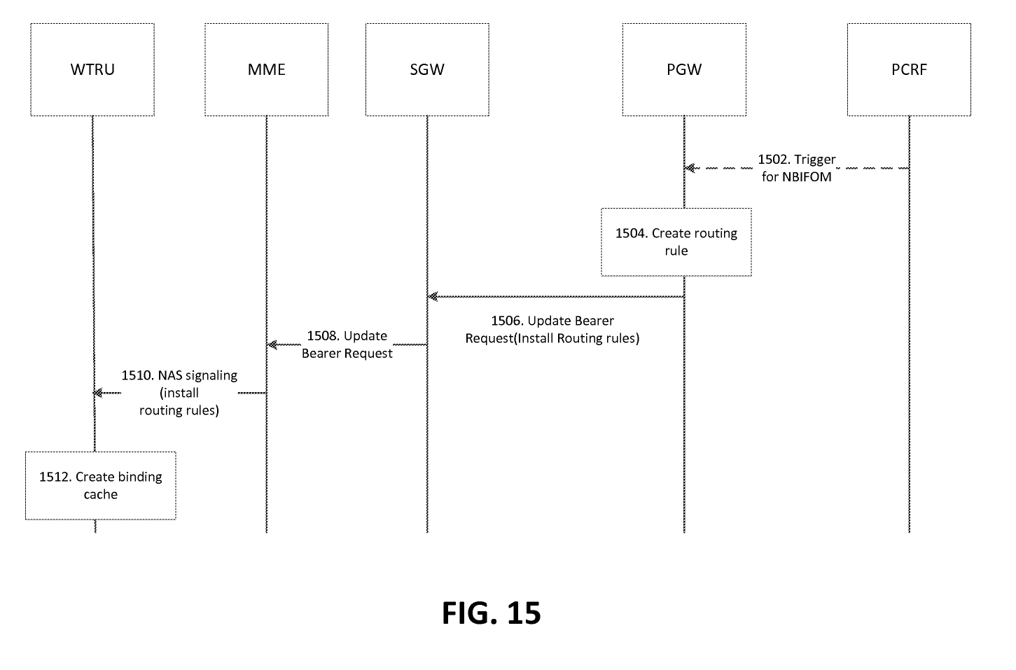

FIG. 15 illustrates an example of NW-initiated IFOM for a Single Connection mode, e.g., via 3GPP signaling. As illustrated in FIG. 15, one or more routing rules may be sent via 3GPP access signaling. The one or more routing rules may be sent from the PGW to the WTRU via 3GPP access signaling (e.g., NAS), e.g., if the one or more routing rules are provided via 3GPP access.

As illustrated in FIG. 15, at 1502, the PCRF may provide a trigger to the PGW via a Gx reference point to change an IP flow via particular access (e.g., WLAN or 3GPP). This trigger may be based on a PCC trigger from subscription information, packet inspection via TDF, usage monitoring, and/or congestion information from RAN. The PCRF may provide the one or more routing rules to the PGW.

The PGW may decide to trigger network-initiated NB-IFOM, for example, based on a trigger by the PCRF and/or static configuration. At 1504, the PGW may create a one or more routing rules for the IP flows to be moved to different access. At 1506, the PGW may include the one or more routing rules to a message towards the SGW. The PGW may include the one or more routing rules to the PDN connection where traffic (e.g., related to IP flows) is offloaded from WLAN. The one or more routing rules may be provided within an Update Bearer Request via GTP S2a.

The PCRF may provide the one or more routing rules directly to the SGW via a Gxx reference point using PCC procedures, e.g., if PMIP S2a is used. In such scenarios, among others, the PCRF may provide the one or more routing rules and APN information of the PDN connection, e.g., where traffic from WLAN is offloaded. The PGW may provide the one or more routing rules within a Flow Mobility Initiate (FMI) message.

At 1508, the SGW may forward the one or more routing rules within an Update Bearer request message towards the WTRU. At 1510, the MME may obtain the one or more routing rules information and/or may forward the one or more routing rules within a NAS message towards the WTRU. At 1512, the WTRU may create a binding cache based on the one or more routing rules and/or may forward uplink data of the same IP flow over the corresponding access gateway. The WTRU may use Logical Interface functionality (LIF) to support IFOM.

IFOM for WTRUs supporting Multi-Connection mode may be provided. The IFOM may be initiated by a WTRU or a network. WTRU-initiated NB-IFOM in Multi-Connection mode is provided. For a WTRU that has negotiated Multi-Connection mode, perhaps for example in order to support IFOM, among other scenarios, the WTRU may provide one or more routing rules over the WLCP protocol towards a Trusted WLAN Access Gateway (TWAG). An IE may be used within the WLCP protocol in order to convey the one or more routing rules information. The TWAG may forward the one or more routing rules to the PGW, e.g., over an S2a reference point.

The WTRU may obtain one or more routing rules from the ANDSF. The one or more routing rules may include one or more of a Home Address (WTRU IP address), a Routing Address (e.g., TWAG or SGW address), a PDN Connection ID (PDN ID) e.g., when the WTRU has multiple PDN connections via WLAN, a Flow ID, a Flow ID priority, and/or a description of IP flows.

The PGW may receive the one or more routing rules from the WTRU. The PGW may generate a binding cache with the routing address (e.g., MAG address). Based on the binding cache, the PGW may send the downlink data to the corresponding access gateway. The TWAG may forward the IP flow to the corresponding PDN connection based on the routing rule table, e.g., if the IP flow is sent towards the TWAG.

One or more embodiments of sending one or more routing rules for single connection WTRUs, set forth herein, apply to multi-connection WTRUs. For multi-connection WTRUs, the WTRU may include, for example, an identifier to link to the PDN connection over S2a where the one or more routing rules are sent.

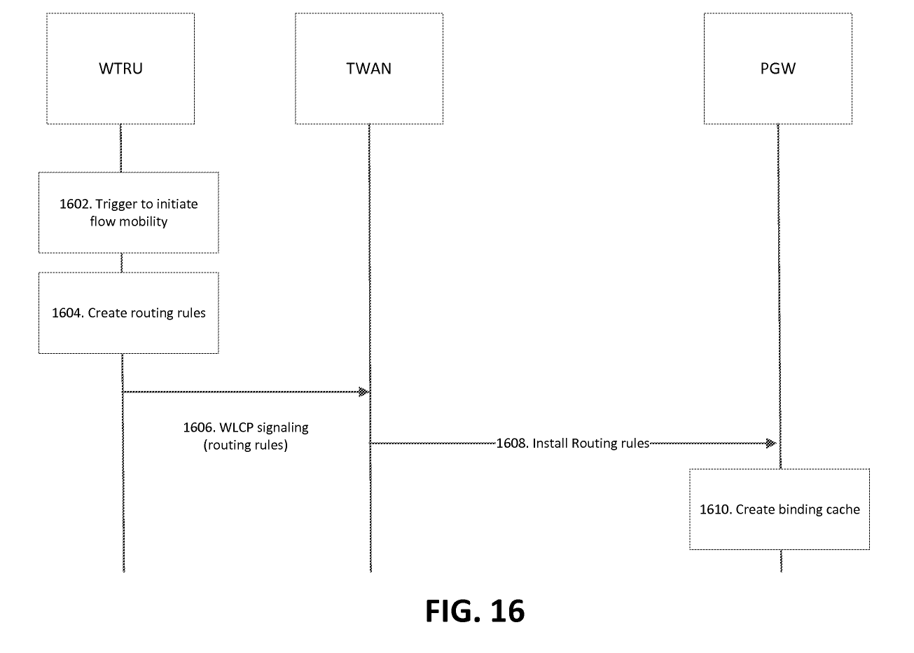

FIG. 16 illustrates an example of WTRU-initiated NB-IFOM for a Multi-Connection mode via WLCP signaling. As illustrated in FIG. 16, a WTRU may send one or more routing rules via WLAN access using WLCP protocol between WTRU and TWAN. At 1602, the WTRU may receive a trigger to initiate NB-IFOM to WLAN access (e.g., via an ANDSF policy or a RAN rule).

At 1604, the WTRU may create one or more routing rules to move IP flows from 3GPP to WLAN taking into account the information, e.g., provided by the ANDSF rule (e.g., IP flows, APN information) or the RAN rules. At 1606, the WTRU may include the one or more routing rules within WLCP signaling towards the TWAN. The WTRU may include APN information for the PDN connection where the IP flows may be moved.

At 1608, the TWAN may determine the PDN connection to forward the one or more routing rules and/or may send the one or more routing rules to the PGW, e.g., via an S2a reference point. The one or more routing rules are sent within a within the Create Session request (e.g., if NB-IFOM requires a new PDN connection over WLAN) or Modify Bearer Command or Modify Bearer Request signaling (e.g., if NB-IFOM is made on an existing PDN connection), e.g., if GTP S2a is used between the PGW and the TWAN. The one or more routing rules are sent within a Proxy Binding Update message, e.g., if PMIP S2a is used between the PGW and the TWAN.

At 1610, the PGW may generate the binding cache with the routing address (e.g., MAG address). Based on the binding cache, the PGW may send the downlink data to the corresponding access gateway.

A WTRU may send one or more routing rules via 3GPP access signaling. The WTRU may send one or more routing rules via 3GPP access signaling or via WLAN signaling via the TWAN towards the 3GPP access.

Network-Initiated NB-IFOM in Multi-Connection mode may be useful. A PGW may provide one or more routing rules to the WTRU, e.g., over 3GPP or WLAN access. The PGW may obtain one or more routing rules information from PCRF over a Gx reference point, perhaps for example based on routing policies installed at the PCRF, among other scenarios. The PGW may send the one or more routing rules information over an S2a reference point towards the TWAG of the SaMOG WLAN, e.g., if the one or more routing rules are provided via WLAN access. The TWAG may forward the one or more routing rules to the WTRU using the WLCP protocol. The WTRU may create a binding cache based on the one or more routing rules and/or may forward uplink data of the same IP flow over the corresponding access gateway. The WTRU may use Logical Interface functionality (LIF) to support IFOM.

The embodiments of sending one or more routing rules for single connection WTRUs described herein may be applied to multi-connection WTRUs. For multi-connection WTRUs, the TWAN and WTRU may share an identifier to link the IP flows to the appropriate PDN connection over S2a where the one or more routing rules are sent.

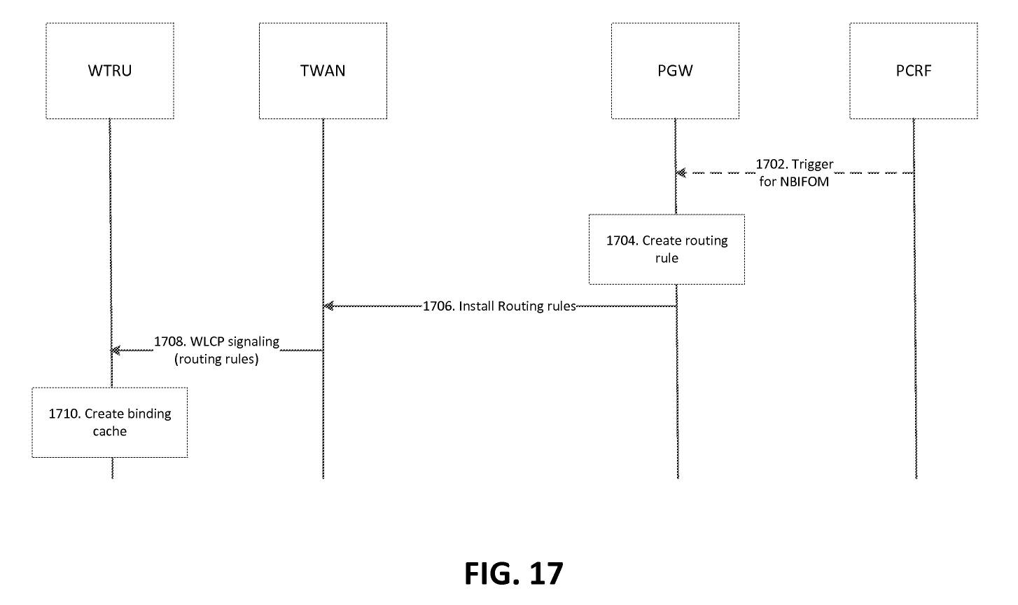

FIG. 17 illustrates an example of NW-initiated NB-IFOM for a Multi-Connection mode via WLCP signaling. As illustrated in FIG. 17, a TWAN may send one or more routing rules sent via WLAN access using WLCP protocol between TWAN and WTRU.

As illustrated in FIG. 17, at 1702, the PCRF may provide a trigger to a PGW via a Gx reference point to change an IP flow via particular access (e.g., WLAN or 3GPP). This trigger may be based on a PCC trigger from subscription information, packet inspection via TDF, usage monitoring, and/or congestion information from RAN. The PCRF may provide the one or more routing rules to the PGW.

At 1704, the PGW may decide to trigger network-initiated NB-IFOM, for example, based on a trigger by the PCRF and/or static configuration. At 1706, The PGW may create one or more routing rules for the IP flows to be moved to different access. The PGW may include the one or more routing rules to a message towards a TWAN. The one or more routing rules may be provided within an Update Bearer Request, e.g., via GTP S2a. The PGW may provide the one or more routing rules within a Flow Mobility Initiate (FMI) message, e.g., if PMIP S2a is used.

The PCRF may provide the one or more routing rules, e.g., directly to the TWAN via a Gxx reference point using PCC procedures. In such scenarios, among others, an interface between TWAN and PCRF may be provided.

At 1708, the TWAN may determine based on the one or more routing rules on which APN the flow mobility applies and/or may send the one or more routing rules, e.g., via the WLCP protocol to the WTRU. The TWAN may include the one or more routing rules and/or APN information.

At 1710, the WTRU may create a binding cache based on the one or more routing rules and/or may forward uplink data of the same IP flow over the corresponding access gateway. The WTRU may use Logical Interface functionality (LIF) to support IFOM.

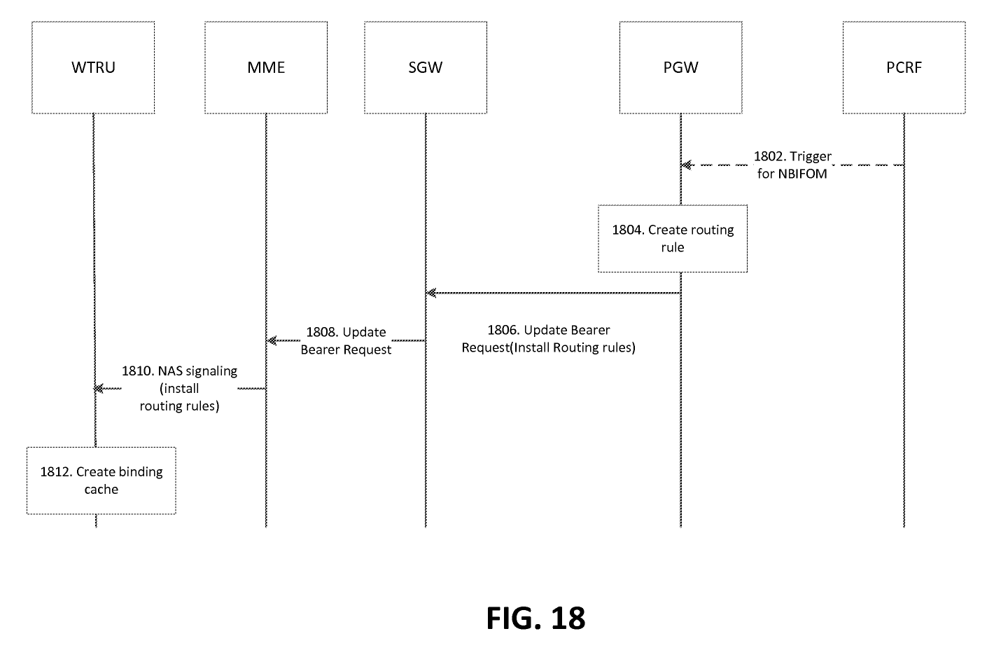

FIG. 18 illustrates an example of NW-initiated NB-IFOM for a Multi-Connection mode, e.g., via 3GPP signaling. As illustrated in FIG. 18, one or more routing rules may be sent via 3GPP access signaling. The one or more routing rules may be sent from the PGW to the WTRU via 3GPP access signaling (e.g., NAS), e.g., if the one or more routing rules are provided via 3GPP access.

As illustrated in FIG. 18, at 1802, the PCRF may provide a trigger to the PGW via a Gx reference point to change an IP flow via particular access (e.g., WLAN or 3GPP). This trigger may be based on a PCC trigger from subscription information, packet inspection via TDF, usage monitoring, and/or congestion information from RAN. The PCRF may provide the one or more routing rules to the PGW.

At 1804, the PGW may decide to trigger network-initiated NB-IFOM, for example, based on a trigger by the PCRF and/or static configuration. The PGW may create one or more routing rules for the IP flows to be moved to different access. At 1806, the PGW may include the one or more routing rules in a message towards the SGW. The PGW may include the one or more routing rules to the PDN connection, e.g., where traffic (e.g., IP flows) from WLAN is offloaded. The one or more routing rules may be provided, for example, within an Update Bearer Request via GTP S2a.

The PCRF may provide the one or more routing rules directly to the SGW via a Gxx reference point using PCC procedures, e.g., if PMIP S2a is used. In such scenarios, among others, the PCRF may provide the one or more routing rules and/or APN information of the PDN connection, e.g., where traffic from WLAN is offloaded. The PGW may provide the one or more routing rules within a Flow Mobility Initiate (FMI) message.

At 1808, the SGW may forward the one or more routing rules within an Update Bearer request message towards the WTRU. At 1810, the MME may obtain the one or more routing rules information and/or may forward the one or more routing rules within a NAS message towards the WTRU.

At 1812, the WTRU may create a binding cache based on the one or more routing rules and/or may forward uplink data of the same IP flow over the corresponding access gateway. The WTRU may use Logical Interface functionality (LIF) to support IFOM.

A RAN may trigger the flow mobility. RAN triggered flow mobility may be referred to as NB-IFOM. One or more of the NB-IFOM techniques described herein may be used to support RAN triggered flow mobility. One or more of the techniques described herein with respect to RAN triggered may be used in conjunction with the other NB-IFOM methods described herein.

The RAN (e.g., eNodeB or RNC) may decide to offload traffic and/or may send to the WTRU a command to offload traffic using an RRC message, e.g., RRC Reconfiguration message. This command may include traffic, for example, at the bearer level, IP flow level, PDN level, and/or APN level. When the traffic offload instruction is provided at the bearer level, for example, among other scenarios, the WTRU may translate the bearer information into IP flow information. The WTRU may use one or more, or any, other flow granularity (e.g., PDN connection) suitable for the initiation of NB-IFOM by the WTRU as described herein. The operator policy and/or rules for traffic offload that may be used together with other RAN considerations (e.g., RRM considerations) in the RAN for traffic offload decision may be configured in the RAN and/or signaled to the RAN from the core network.

The WTRU may initiate NB-IFOM as described herein, e.g., when the WTRU receives a traffic offload command from the RAN. The WTRU may initiate (e.g., implicitly initiate) NB-IFOM by offloading uplink traffic as the traffic granularity is received from the RAN (e.g., bearers indicated by RAN) to WLAN or to (E-)UTRAN. Upon detection of uplink traffic flow on WLAN and/or onto (E-)UTRAN, for example, among other scenarios, a PGW may move the corresponding DL traffic flow to the same access network e.g., WLAN or (E-)UTRAN as the uplink traffic.

The RAN (e.g., eNodeB or RNC) may decide to offload traffic and/or may send to an SGW a message (for e.g., over GTP-c) as a trigger to initiate NB-IFOM. Such messages, for example, among others, may include the traffic to be offloaded, e.g., the bearers to be offloaded, the IP flow to be offloaded, PDN connection, and/or APN to be offloaded. The SGW may relay the trigger for NB-IFOM to the PGW and/or to the PCRF. The PGW and/or the PCRF may initiate the NB-IFOM toward the PGW. The message to trigger NB-IFOM from the RAN may include additional information, such as the direction of the offload (e.g., from WLAN to (E-)UTRAN from (E-)UTRAN to WLAN).

The RAN (e.g., eNodeB or RNC) may decide to offload traffic and/or send to the MME or SGSN a message (for e.g., over GTP-c) as a trigger to initiate NB-IFOM. For example, such messages, among others, may be an S1 Application Part (S1-AP) message and/or a Radio Access Network Application Part (RANAP) message. The message may include the traffic to be offloaded e.g., the bearers to be offloaded, the IP flow to be offloaded the PDN connection, and/or the APN to be offloaded, etc. It may include additional information such as the direction of the offload (e.g., from WLAN to (E-)UTRAN or from (E-)UTRAN to WLAN). The MME and/or SGSN may relay the NB-IFOM trigger message toward the SGW, for example, over the GTP-C interface. The SGW may relay the trigger for NB-IFOM to the PGW and/or to the PCRF, that may initiate the NB-IFOM toward the PGW as described herein.

Systems, methods, instrumentalities of minimizing service disruption may be provided, e.g., when there is loss of WLAN access. For example, when a WTRU moves out of a WLAN coverage, among other scenarios, such a movement may result in service disruption, perhaps if the WTRU has flows via the WLAN access.

The WTRU may be in a position to determine the loss of WLAN coverage. The WTRU may trigger WTRU-initiated NBIFOM, perhaps for example to move the flows that are sent via the WLAN access back to the 3GPP access, e.g., when a WTRU has flows sent over the 3GPP and WLAN access using the same APN. The WTRU may move one or more of the flows that were sent via the WLAN for WTRU-initiated and/or NW-initiated NBIFOM trigger, as well as one or more of the flows sent via the WLAN that can be (e.g., seamlessly) routed back to the 3GPP access. The WTRU may provide a flag to notify the PGW the reason for moving the flows back to 3GPP access. The PGW may use such information for notification as to why flows that were sent to WLAN via NW-triggered NBIFOM are routed back to 3GPP.

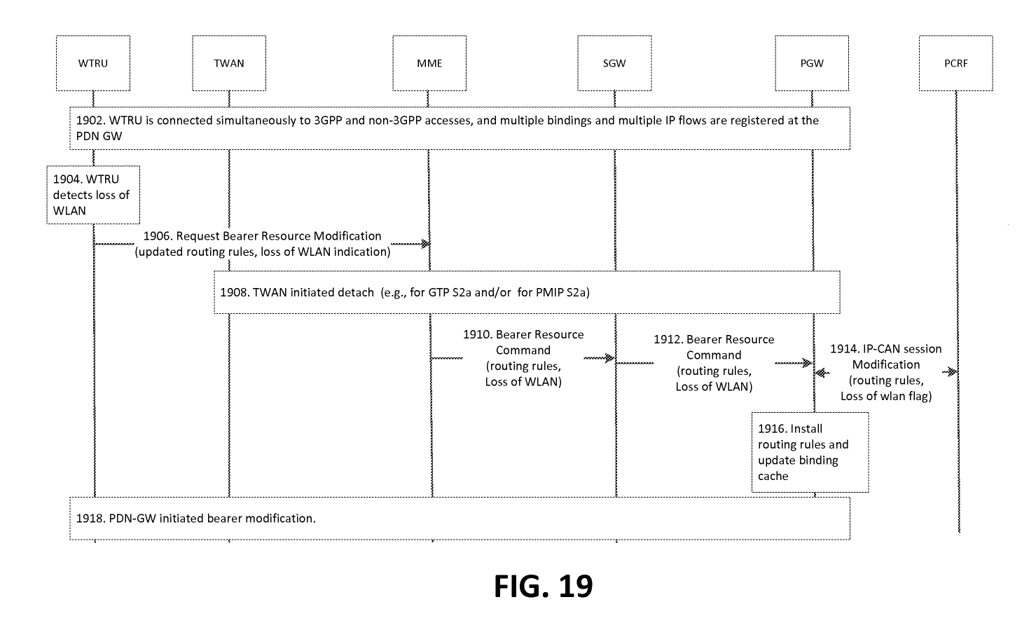

FIG. 19 illustrates an example of NBIFOM in case of loss of WLAN access for GTP. At 1902, a WTRU may be simultaneously connected to 3GPP and WLAN access via an APN (e.g., a same APN). The WTRU may have flows routed, e.g., over the 3GPP access and over the WLAN access using the same APN. The WTRU may have IP flows routed via WLAN based on WTRU-initiated and/or NW-initiated NBIFOM.

At 1904, the WTRU may check its binding cache and/or may create one or more routing rules to move flows that were routed over WLAN to the 3GPP access using the same APN, e.g., when the WTRU detects loss of WLAN access. The WTRU may move the flows that were sent via the WLAN for a WTRU-initiated and/or NW-initiated NBIFOM trigger as well as the flows sent via the WLAN that can be (e.g., seamlessly) routed back to the 3GPP access. In an updated routing rules information, for example, the WTRU may create one or more routing rules to move one or more IP flows that were moved to WLAN based on a NW-initiated trigger, for example.

At 1906, the WTRU may send the updated one or more routing rules information within a Request Bearer Resource Modification message. The WTRU may include an indication of loss of WLAN. The indication may be sent to inform a PGW, for example, among other things, as to why IP flows that were moved based on a NW-initiated NBIFOM trigger are moved back via the 3GPP access.

At 1908, perhaps for example due to loss of WLAN connection, the TWAN may initiate a TWAN initiated detach. The TWAN initiating detach may be carried out simultaneously with the WTRU sending the updated one or more routing rules information and WTRU's indication of loss of WLAN. At 1910 and 1912, the updated one or more routing rules information and/or the indication of loss of WLAN may be sent to the PGW via an SGW within a Bearer Resource Command.

At 1914, the PGW may provide the one or more routing rules and/or loss of flag information to PCRF, e.g., if PCC is supported by the network operator. The PCRF may update its binding cache and/or provide updated PCC rules with routing information to the PGW.

At 1916, the PGW may update its binding cache. The PGW may update its routing rule table that flows that were moved by a NW-initiated trigger to the WLAN are moved back to 3GPP due to loss of WLAN. At 1918, the PGW may initiate a bearer modification procedure.

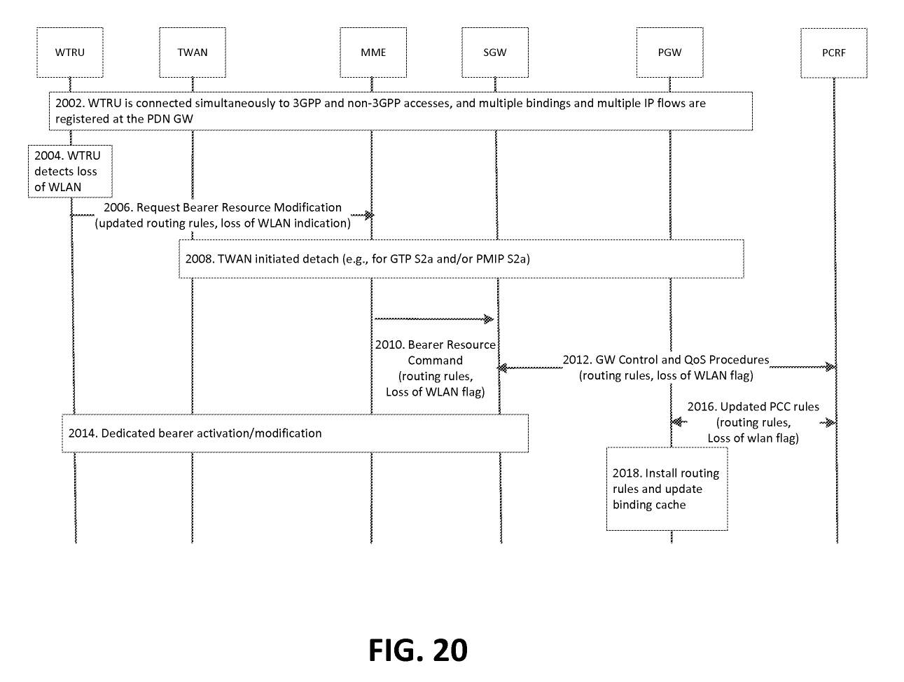

FIG. 20 illustrates an example of NBIFOM in case of the loss of WLAN access for PMIP. At 2002, a WTRU may be simultaneously connected to, e.g., 3GPP and WLAN access via the same APN. The WTRU may have flows routed over the 3GPP access and over the WLAN access using an APN (e.g., the same APN). The WTRU may have IP flows routed via WLAN based on WTRU-initiated or NW-initiated NBIFOM.

At 2004, perhaps for example when the WTRU detects loss of WLAN access, among other scenarios, the WTRU may check its binding cache and may create one or more routing rules to move one or more IP flows that were routed over WLAN to the 3GPP access using the same APN. The WTRU may move the flows that were sent via the WLAN for a WTRU-initiated and/or NW-initiated NBIFOM trigger, as well as the flows sent via the WLAN that can be (e.g., seamlessly) routed back to the 3GPP access. In the updated one or more routing rules information, for example, the WTRU may create one or more routing rules to move IP flows that were moved to WLAN based on a NW-initiated trigger, for example.

At 2006, the WTRU may send the updated one or more routing rules information within a Request Bearer Resource Modification message. The WTRU may include an indication of loss of WLAN. The indication may be sent, for example, to inform a PGW as to why IP flows that were moved based on a NW-initiated NBIFOM trigger are moved back via the 3GPP access.

At 2008, perhaps for example due to loss of WLAN connection, among other scenarios, a TWAN may initiate a TWAN initiated detach. The TWAN initiated detach may be carried out simultaneously with the WTRU sending the updated one or more routing rules information and WTRU's indication of loss of WLAN.

At 2010, the updated one or more routing rules information and the indication of loss of WLAN may be sent to an SGW within a Bearer Resource Command. At 2012, the SGW may send one or more routing rules and/or loss of flag information to PCRF, e.g., within a Gateway Control and QoS request message. At 2014, bearer modification procedures may be carried out for PMIP based S5 networks.

At 2016, the PCRF may provide updated PCC rules with one or more routing rules information and/or loss of flag indication to the PGW. At 2018, the PGW may update its binding cache and/or may inform the PCRF. The PGW may update its routing rule table that flows that were moved by a NW-initiated trigger to the WLAN are moved back to 3GPP due to loss of WLAN.

The PCRF may include a binding cache with one or more routing rules information. In such scenarios, among others, the PCRF may contain the one or more routing rules binding cache and/or may inform the PGW via PCC rule provisioning whether flows may be sent via different access.

The routing rule information and/or loss of WLAN may be provided within a Proxy Binding Update message from the SGW to the PGW. This may be done after the bearer modification procedures are carried out, for example.

The procedures upon loss of WLAN for a WTRU connected via a PMIP/GTP S2b to the 3GPP access may be similar to the techniques described herein, for example in relation to FIG. 19 and/or FIG. 20, but perhaps with an ePDG.1, instead of the TWAN.

One or more, or every, dedicated EPS bearer may be associated with traffic flow template (TFT) information. Uplink bearers may be associated with uplink TFT filters and/or downlink bearers with may be associated downlink TFT filters. TFT information may be included in default bearers.

Within a TFT filter, one or more of the following information may be defined for a bearer: source address (with subnet mask); IP protocol number (TCP, UDP); destination port range; source port range; PSec Security Parameter Index (SPI); type of Service (TOS) (IPv4); and/or flow-Label (IPv6 only).

It may be useful in 3GPP for NBIFOM to resolve conflicts between WTRU-initiated and/or NW-initiated NBIFOM. For example, one or more techniques may be useful to avoid the application of both WTRU initiated and network initiated NB-IFOM to a PDN connection that may lead to conflicts, among other scenarios.

The PGW may be aware that the WTRU is connected to a SaMOG WLAN, perhaps because an S2a connection is established between the TWAN and the PGW. Embodiments recognize that the PGW might have no indication whether the WTRU has actual radio connectivity with the WLAN access and/or if the WTRU loses radio connectivity to a WLAN access. For such reasons, among others, the TWAN may not (e.g., immediately) release the related S2a connection to the PGW and/or the TWAN may start a timer before it releases the S2a connection. The PGW may initiate a network-triggered NBIFOM while the WTRU has no WLAN radio connectivity. In such scenarios, among others, the NW-initiated NBIFOM procedure may fail. One or more techniques are contemplated that may allow the PGW and/or PCRF to be aware that the WTRU has radio connectivity to a WLAN access.

One or more techniques are contemplated that may provide NBIFOM triggers via TFT filters and/or how RAN provided 3GPP and/or WLAN thresholds may assist the WTRU to decide to move flows to a 3GPP or WLAN access, perhaps for example based on a NW-initiated trigger.

One or more embodiments contemplate conflict resolution between WTRU-initiated and NW-initiated NBIFOM. For example, the PCRF and PGW may be the main entities controlling NBIFOM for both WTRU-initiated and NW-initiated triggers for NBIFOM. The PCRF and/or PGW may maintain a routing rule table and/or may decide whether rules containing IP flows may be under WTRU and/or NW control.

For WTRU-initiated NBIFOM, the WTRU may provide one or more routing rules information with IP flows that may be moved to a different access (e.g., either via WLAN and/or via 3GPP). The PGW may check with PCRF over Gx reference point whether the IP flow mobility may be approved. For example, upon PCRF authorization, among other scenarios, the PGW may provide to the WTRU the authorization (e.g., in the routing rule acknowledge message).

For NW-initiated NBIFOM, the PCRF may provide one or more policies to the PGW for moving flows between accesses. In such scenarios, among others, the PCRF and/or PGW may be aware that the WTRU supports NBIFOM and/or is connected to a WLAN. Perhaps for example when the NW triggers NBIFOM, among other scenarios, the WTRU may either accept (e.g., if WLAN conditions are good), or reject the flow mobility (or accept some flow mobility and reject other flow mobility, for example). Thresholds provided by the RAN may be considered. The WTRU may provide authorization in the routing rule acknowledge message towards the PGW, for example, among other scenarios.

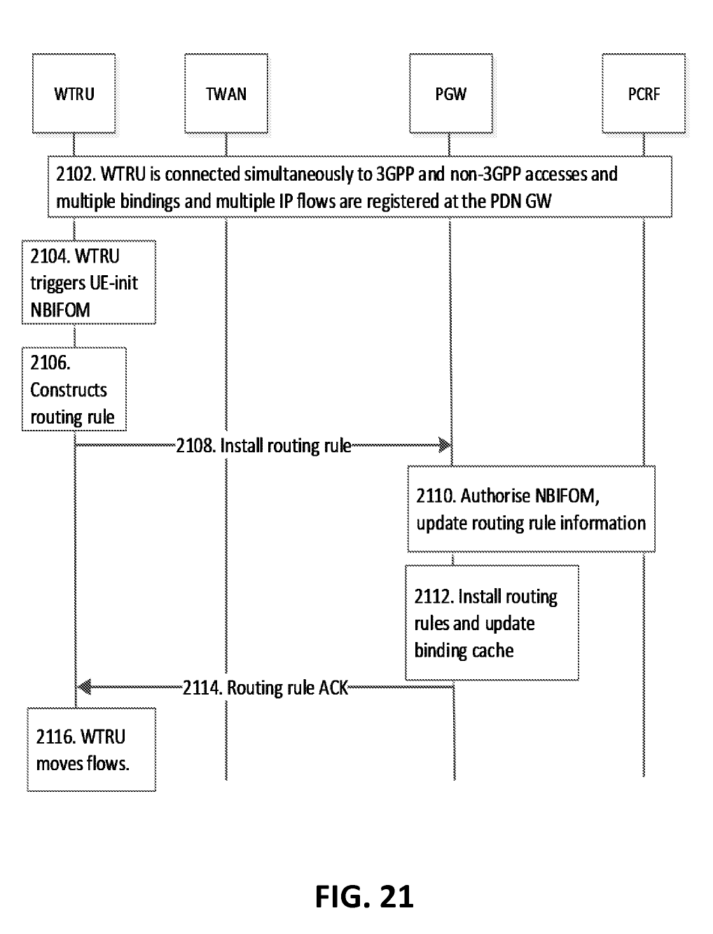

Conflict resolution during WTRU-initiated NBIFOM is contemplated. FIG. 21 is an example of a technique that may resolve conflicts for WTRU initiated NBIFOM. At 2102, the WTRU may be connected to 3GPP and WLAN access. At 2104, the WTRU may trigger a WTRU initiated NBIFOM, perhaps for example based: on one or more ANDSF policies (ANDSF rules), per PDN connection offload policies from the MME (RAN rules), and/or a user trigger.

At 2106, the WTRU may construct one or more routing rules (perhaps for example similar to those shown in Tables 1 and 2). At 2108, the WTRU may transmit it/them to the PGW via WLAN and/or 3GPP access signaling.

At 2110, perhaps for example upon receiving one or more routing rules information, among other scenarios, the PGW may transmit the request for WTRU-initiated NBIFOM and/or the one or more routing rules information to the PCRF. The PCRF may check whether the IP flows are authorized to be moved by a WTRU-initiated NBIFOM procedure and/or may check if these IP flows are currently under a NW-initiated NBIFOM trigger. For example, if there are no conflicts, the PCRF may authorize the WTRU-initiated NBIFOM procedure. The PCRF may maintain a table for example to be aware that these IP flows are under WTRU controlled NBIFOM and/or respond to the PGW with authorization.

At 2112, perhaps for example once the PGW obtains authorization, among other scenarios, the PGW may update its binding table. The PGW may include in its binding table that these IP flows are under WTRU controlled NBIFOM.

At 2114, the PGW may provide the WTRU with authorization to initiate a WTRU-initiated NBIFOM procedure. The PGW may provide a routing rule table to the WTRU, for example indicating the current active rules for NBIFOM, and/or that may include which rules are under network control and/or which rules are under WTRU control.

At 2116, perhaps for example once the WTRU may obtain the authorization, among other scenarios, the WTRU may move the flows to the target access based on the information contained in the one or more routing rule(s).

Table 3 is an example routing route table indicating which rules are under WTRU and/or network control.

TABLE 3

| Routing | | Bind- | BID | | FID | | |
|---|---|---|---|---|---|---|---|
| rule | Routing | ing | Pri- | Flow | Pri- | Routing | NBIFOM |
| name | Address | ID | ority | ID | ority | Filter | control |
| Rule | WLAN | BID1 | x | FID1 | a | Description | WTRU |
| Name 1 | | | | | | of IP | |
| | | | | | | flows . . . | |
| | | | | FID2 | b | Description | NW |
| | | | | | | of IP | |
| | | | | | | flows . . . | |
| Rule | 3GPP | BID2 | y | FID3 | . . . | . . . | NW |
| Name 2 | | | | | | | |

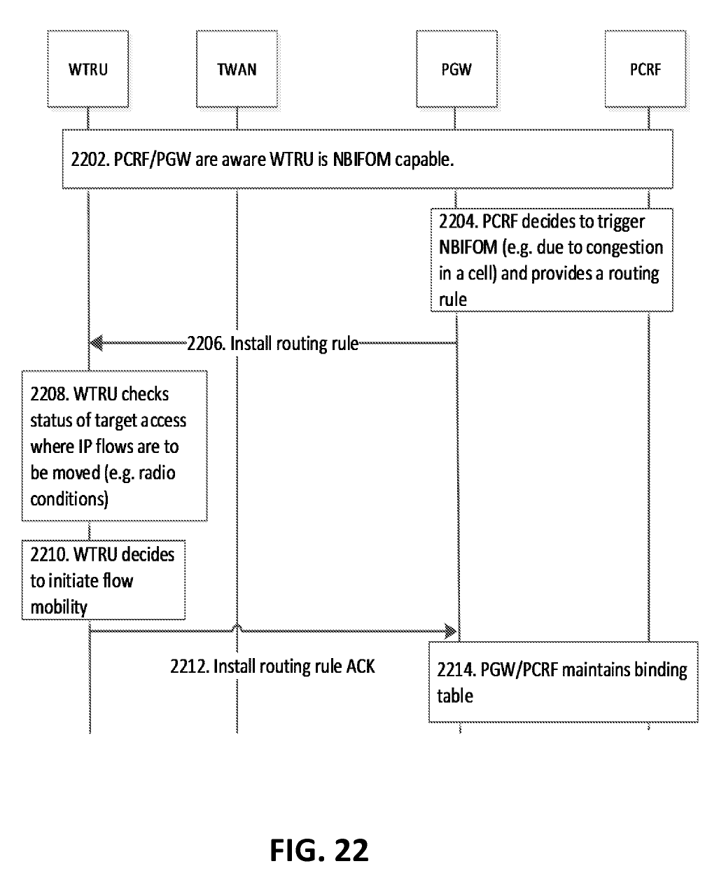

One or more techniques for conflict resolution during NW-initiated NBIFOM are contemplated. FIG. 22 illustrates an example techniques that may resolve conflicts for NW-initiated NBIFOM.

At 2202, the WTRU may be connected to 3GPP and WLAN access. The PGW may be aware that the WTRU is NBIFOM capable and/or that the WTRU has radio connectivity to the WLAN access.

At 2204, the PCRF may decide to trigger a network-initiated NBIFOM procedure, perhaps for example based on information received by the RAN on RAN congestion, subscriber profile, usage limits, and/or credit limits, among other factors. The PCRF may check whether the IP flows are authorized to be moved by a NW-initiated NBIFOM procedure and/or may check if these IP flows are currently under a WTRU-initiated NBIFOM control. Perhaps for example if there are no conflicts, among other scenarios, the PCRF may authorize the NW-initiated NBIFOM procedure.

At 2206, the PGW may construct one or more routing rules (e.g., similar to those shown in Tables 1 and 2) and/or may transmit it/them to the WTRU via WLAN and/or 3GPP access. The PGW may provide a routing rule table to the WTRU that may indicate the current active rules for NBIFOM, and/or that may include which rules are under network control and/or which rules are under WTRU control (e.g., see Table 3).

At 2208, perhaps for example upon receiving routing rule information, among other scenarios, the WTRU may check the current WLAN conditions (e.g., if the one or more rules indicate to move the one or more IP flows to a WLAN access) and/or current 3GPP conditions (e.g., if the one or more rules indicate to move the one or more IP flows to a 3GPP access). The WTRU may also consider thresholds provided from the RAN via RAN assistance information, perhaps for example before deciding to move the IP flows to the target access, among other scenarios.

At 2210, perhaps for example if the WTRU authorizes the NW-initiated NBIFOM procedure, among other scenarios, the WTRU may move the IP flows to the target access. At 2212, the WTRU may respond to the PGW with a Routing Rule ACK message.

At 2214, the PGW and/or the PCRF may update their binding tables. The PCRF and/or the PGW may maintain a table, perhaps for example in order to be aware that these one or more IP flows are under network controlled NBIFOM.

Embodiments contemplate one or more conflicts between WTRU-initiated NBIFOM and NW-initiated NBIFOM.

Embodiments recognize that at least one design commonality to many, or all, 3GPP specified solutions up to Rel-12 for traffic offload between a 3GPP access network and a non-3GPP access network (e.g., such as WLAN) is that the WTRU may control traffic offload decisions. The WTRU-initiated NB-IFOM (e.g., the one or more scenarios where a WTRU may triggers NBIFOM) and/or the techniques for traffic offload decision in the WTRU may be well understood. Embodiment recognize that the scenarios in which the network (NW) controls the triggering of NBIFOM might not be as well understood. For example in SA2, techniques may be useful for NW-initiated NBIFOM and/or the techniques that may be used by the network to control traffic offload decision, perhaps for example as opposed to assisting the WTRU that may eventually make the decision.

For example in SA2, at least one working assumption may be that the PCRF may initiate NBIFOM. Techniques may be useful for clarifying how the PCRF (e.g., perhaps based on the policy configured by the operator) may decide to initiate NBIFOM. Techniques may be useful for clarifying the relationship, if any, between the one or more PCRF policies that may be used in the case of NW-initiated NBIFOM and the one or more ANDSF policies that may be used in the case of WTRU-initiated NBIFOM. Techniques may be useful for clarifying the relationship, if any, between the one or more PCRF policies that may be used in the case of NW-initiated NBIFOM and the one or more RAN rules that may be used in the case of WTRU-initiated NBIFOM. For example, in some embodiments, it may be reasonable to assume that the one or more ANDSF policies and the one or more PCRF policies affecting traffic offload decisions may be provisioned by the same operator. In such scenarios, among others, these policies may be consistent with each other. For example, in a roaming scenario, if the WTRU is using one or more V-ANDSF policies (e.g. the WTRU is configured by the home operator to prefer the one or more visiting PLMN operator ANDSF policies), the one or more policies that may be used for the control of NW-initiated NBIFOM are the one or more V-PCRF policies. For example, if the WTRU is using the one or more H-ANDSF policies, the one or more PCRF policies that may be used for the control of NW-initiated NBIFOM are the H-PCRF policies. In some embodiments, it may be reasonable to assume that the RAN assistance information that may be used by the WTRU in the case of RAN rules based access network selection and/or traffic steering decisions and the one or more PCRF policies may belong to the same operator.

In some embodiments, one or more of the following assumptions can be made:

For NW-initiated NBIFOM, the PCRF may initiate NBIFOM;

One or more triggers for NBIFOM, WTRU-initiated and/or NW-initiated, may be based on one or more traffic routing policies configured by the same operator;

One or more ANDSF policies and/or the one or more PCRF policies for access network selection and/or traffic routing may be provisioned by the same operator and/or may be consistent with each other;

RAN assistance information that may be used by the WTRU in the case of RAN rules based access network selection and/or traffic steering decisions and the one or more PCRF policies may be from the same operator; and/or

The one or more ANDSF policies and/or the one or more PCRF policies for access network selection and/or traffic routing may be consistent with each other and/or might not be expected to be a cause for conflicting access network selection and/or traffic routing decisions between the WTRU and the network.

In view of one or more of the assumptions described herein, embodiments contemplate one or more scenarios and/or use cases in which the WTRU and the network may arrive at one or more conflicting traffic offload decisions. For example, one or more of the following scenarios may be encountered.

One or more embodiments recognize that the access network and traffic steering decision at the WTRU may reflect the user preference. At least one Potential Conflict Resolution rule may include WTRU-initiated NBIFOM taking precedence over NW-initiated NBIFOM, because for example the user's preference on WLAN network selection and/or traffic routing may take precedence over one or more ANDSF rules and/or one or more RAN rules.

One or more embodiments recognize that the one or more ANDSF policies in the WTRU may be out-of-date. At least one Potential Conflict Resolution Rule may include the NW-initiated NBIFOM taking precedence over WTRU-initiated NBIFOM where the ANDSF policies in the WTRU are stale. The network (e.g. a PCRF) may make the determination that the one or more ANDSF policies in the WTRU are outdated.

One or more embodiments recognize that the WTRU-initiated NBIFOM decision may be the result of the application of RAN-rules based WLAN/3GPP Radio interworking techniques in the WTRU. At least one Potential Conflict Resolution rule may include the NW-initiated NBIFOM taking precedence over WTRU-initiated NBIFOM.

One or more embodiments contemplate RAN network congestion. Traffic offload decisions in the network may mitigate the RAN network congestion. Such scenarios may be avoided, perhaps for example if Rel-12 WLAN/3GPP radio interworking feature is deployed, as RAN assistance thresholds may be properly set to reflect RAN congestion. The core network (e.g. a PCRF) may determine congestion in the RAN network. A Potential Conflict Resolution rule may include the WTRU-initiated NBIFOM taking precedence over NW-initiated NBIFOM.

One or more embodiments recognize Core Network congestion. In some embodiments, perhaps for example non-seamless offload may be relevant (e.g. only such offload), as the non-seamless offload rules and/or the associated priorities might not (e.g., always) reflect a prioritization that may have been better suited at the time Core Network congestion occurs. At least one Potential Conflict Resolution Rule may include the WTRU-initiated NBIFOM taking precedence over NW-initiated NBIFOM. In some embodiments, it may be assumed that the RAN-assistance information setting can be such that the traffic offload decision is aligned to alleviate congestion in the RAN network and/or the Core Network.

One or more embodiments recognize that the WTRU may lose WLAN connection and/or may steer some, or all, WLAN traffic to the 3GPP access. At least one potential Conflict Resolution rule may include the WTRU-initiated NBIFOM taking precedence over NW-initiated NBIFOM.

One or more embodiments contemplate that in one or more scenarios, or all scenarios, the WTRU-initiated NBIFOM decisions may take precedence over the NW-initiated NBIFOM.

One or more embodiments contemplate that NW-initiated NBIFOM may take precedence over WTRU-Initiated NBIFOM, perhaps for example when the NW makes the determination that the WTRU decision is based on one or more outdated ANDSF policies and/or is based on one or more RAN rules (e.g., perhaps only in such scenarios). One or more embodiments contemplate that, perhaps outside of such scenarios, the WTRU-initiated NBIFOM may take precedence.

The PGW and PCRF may be aware that a WTRU has radio connectivity to a WLAN access.

Embodiments recognize that techniques for NBIFOM propose that the WTRU may transmit to the PGW via PCO information indicating that the WTRU supports NBIFOM. The PGW may use this information in order to be aware whether NW-initiated NBIFOM is supported. The WTRU may provide the NBIFOM indication within PCO information in the (e.g., initial) Attach request.

Embodiments contemplate WLAN connectivity indication via PCO (e.g., a proactive approach). One or more techniques may allow the WTRU to include via PCO information an indication that the WTRU has radio connectivity to WLAN, and/or the PCO information may include an NBIFOM indication. The PGW may use this information for example to ensure that the WTRU has WLAN radio connectivity, perhaps before transmitting a NW initiated NBIFOM request, among other scenarios.

Perhaps for example when the WTRU establishes a connection via a SaMOG WLAN, the WTRU may also indicate (e.g., via 3GPP signaling to the PGW) that the WTRU has radio connectivity to a WLAN access. The WTRU may include the WLAN radio connectivity indication via PCO information. Perhaps for example if the WTRU is already attached to a 3GPP access, among other scenarios, the WTRU may transmit a WTRU requested bearer resource modification in the PCO as an indication of WLAN radio connectivity. Perhaps for example if the WTRU is not attached to a 3GPP access, among other scenarios, the WTRU may include a WLAN radio connectivity indication in the PCO within an (e.g., initial) Attach request.

Perhaps for example if the WTRU has indicated to the PGW that it has radio connectivity to a WLAN access and/or the WTRU loses WLAN radio connectivity, among other scenarios, the WTRU may inform the PGW via a WTRU requested bearer resource modification by removing the indication of WLAN radio connectivity from the PCO.

NBIFOM indication via PCO may be transmitted perhaps for example when (for example only when) the WTRU has radio connectivity with WLAN access (e.g., a proactive approach). The WTRU may provide the NBIFOM indication via PCO perhaps if (e.g., only if) the WTRU establishes PDN connectivity via WLAN access and/or has radio connectivity to the WLAN access. For example, when the WTRU establishes a connection via a SaMOG WLAN and/or the WTRU has radio connectivity to the WLAN access, among other scenarios, the WTRU may also indicate via 3GPP signaling to the PGW the NBIFOM indication via PCO information. For example, if the WTRU is (e.g., already) attached to a 3GPP access, among other scenarios, the WTRU may transmit a WTRU requested bearer resource modification in the PCO as an indication of NBIFOM. For example, if the WTRU is not attached to a 3GPP access, among other scenarios, the WTRU may include an NBIFOM indication in the PCO within the (e.g., initial) Attach request.

Perhaps for example if the WTRU has indicated to the PGW that it has radio connectivity to a WLAN access and/or the WTRU loses WLAN radio connectivity, among other scenarios, the WTRU may inform the PGW via a WTRU requested bearer resource modification by removing the NBIFOM indication from the PCO.

A TWAN may reject NW-initiated NBIFOM, perhaps for example due to a loss of WLAN radio connectivity (e.g., a reactive approach).

The PGW may be aware that the WTRU supports NBIFOM (e.g., via the NBIFOM indication). The PGW might not be aware if the WTRU has WLAN radio connectivity. For example, when the PGW transmits a NW-initiated NBIFOM and/or the WTRU has lost WLAN radio connectivity, among other scenarios, the TWAN may provide a rejection indicating that the WTRU has no WLAN radio connectivity.

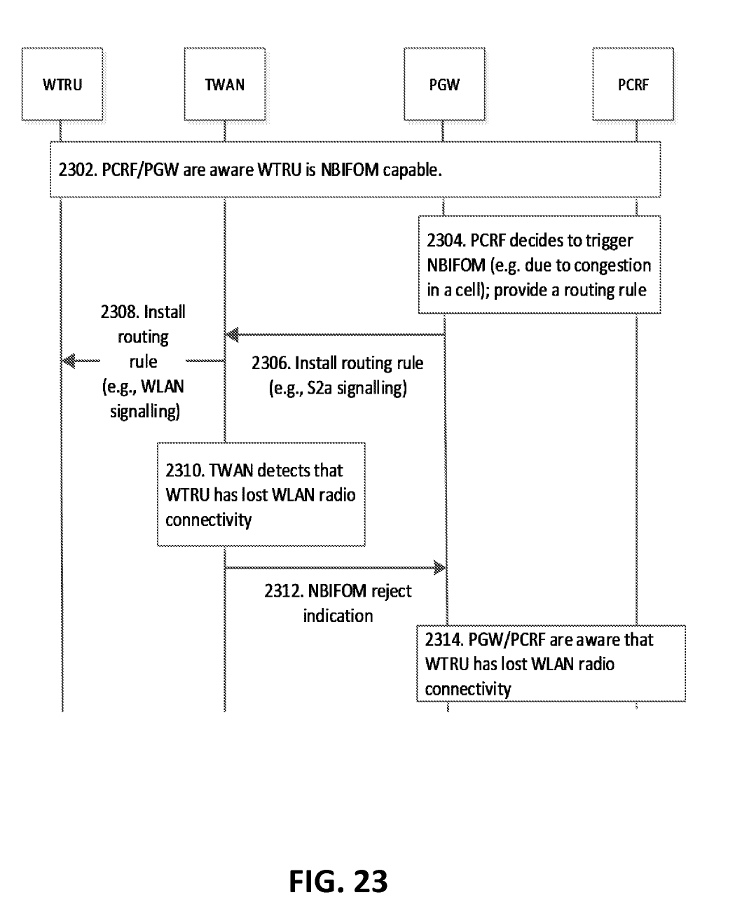

FIG. 23 illustrates an example of the TWAN rejecting network initiated NBIFOM due to loss of WLAN radio connectivity.

At 2302, the WTRU may be connected to 3GPP and WLAN access. The PGW may be aware that the WTRU is NBIFOM capable (e.g., the WTRU may provide NBIFOM indication via PCO).

At 2304, the PCRF may decide to trigger a network-initiated NBIFOM procedure, perhaps for example based on information received by the RAN on RAN congestion, subscriber profile, usage limits, and/or credit limits, among other criteria. The PCRF may check whether the IP flows are authorized to be moved by a NW-initiated NBIFOM procedure and/or may check if these IP flows are (e.g., currently) under a WTRU-initiated NBIFOM control. Perhaps for example if there are no conflicts, among other scenarios, the PCRF may authorize the NW-initiated NBIFOM procedure.

At 2306, the PGW may construct one or more routing rules (e.g., similar to those shown in Tables 1 and 2) and/or may transmit it/them to the WTRU (e.g., via an S2a connection towards the TWAN of the WLAN access). At 2308, the TWAN may (e.g., attempt to) send the one or more routing rules to the WLAN (e.g., via WLAN signaling).

At 2310, the TWAN may detect loss of the WLAN. For example, the WTRU's WLAN radio signaling (e.g., WLCP signaling for multi-connection WTRUs and/or EAP signaling of single-connection WTRUs) of the corresponding S2a connection might not be available. The TWAN may start a timer, perhaps for example in order to wait for the WTRU to re-establish the WLAN connection, among other scenarios.

At 2312, the TWAN may reject the network-initiated NBIFOM request, for example with an indication via S2a connection towards the PGW indicating loss of WLAN connection. The TWAN may provide the reason within the routing rule information.

At 2314, the PGW and/or the PCRF (e.g., via PCC signaling) may be aware that the WTRU has no WLAN connectivity. The PGW and/or PCRF may start a timer and/or may retransmit the request at a later time while the TWAN maintains the S2a connection corresponding to the WLAN access alive, for example.

One or more techniques contemplate that the TWAN might not transmit an explicit indication that the WTRU has lost WLAN connection. The PGW, perhaps for example upon transmitting one or more NW-initiated NBIFOM routing rules, may start a timer. For example, if the timer expires and/or the PGW has not received an acknowledgment from the WTRU and/or the TWAN, among other scenarios, the PGW may assume that the WTRU has lost connection to the WLAN access.

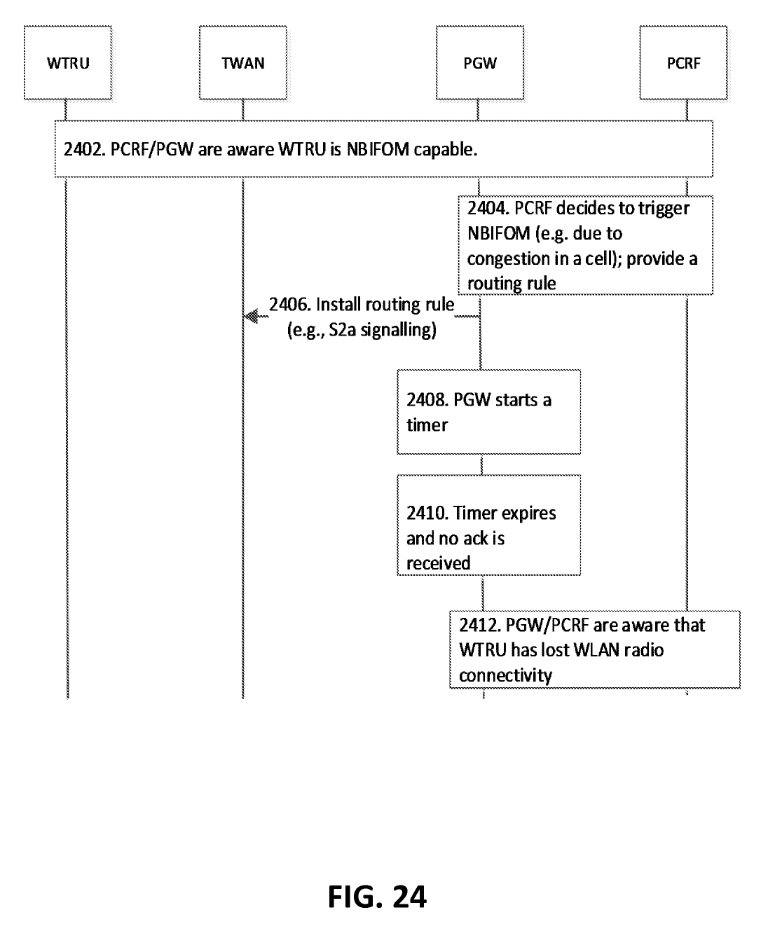

FIG. 24 illustrates an example of the WTRU losing WLAN radio connectivity. At 2402, the WTRU may be connected to 3GPP and WLAN access. The PGW may be aware that the WTRU is NBIFOM capable (e.g., the WTRU may provide NBIFOM indication via PCO).

At 2404, the PCRF may decide to trigger a network-initiated NBIFOM procedure, perhaps for example based on information received by the RAN on RAN congestion, subscriber profile, usage limits, and/or credit limits, among others. The PCRF may check whether the IP flows are authorized to be moved by a NW-initiated NBIFOM procedure and/or may check if these IP flows are (e.g., currently) under a WTRU-initiated NBIFOM control. Perhaps for example if there are no conflicts, among other scenarios, the PCRF may authorize the NW-initiated NBIFOM procedure.

At 2406, the PGW may construct one or more routing rules (e.g., similar to those shown in Tables 1 and 2) and/or may transmit it to the WTRU via an S2a connection towards the TWAN of the WLAN access.

At 2408, the PGW may start a timer and/or may wait for an ack from the WTRU/TWAN that the rule has been installed. At 2410, the timer may expire. Perhaps for example upon the expiration, among other scenarios, the PGW may assume that the WTRU has lost WLAN connectivity.

At 2412, the PGW and/or PCRF (e.g., via PCC signaling) may be aware that the WTRU has no WLAN connectivity. The PGW and/or PCRF may start a timer and/or may retransmit the request at a later time, perhaps for example while the TWAN keeps the S2a connection corresponding to the WLAN access alive.

One or more techniques contemplate that RAN assistance thresholds may be used for network-initiated NBIFOM. The network may decide to trigger NBIFOM and/or may be assisted by RAN assistance information transmitted to the WTRU.

Perhaps for example before the WTRU moves one or more IP flows due to a network initiated NBIFOM trigger from the EPC network (for example, PCRF/PGW), the WTRU may check the thresholds provided through RAN assistance information, perhaps in order to ascertain whether the IP flows may be moved to a different access, among other scenarios.

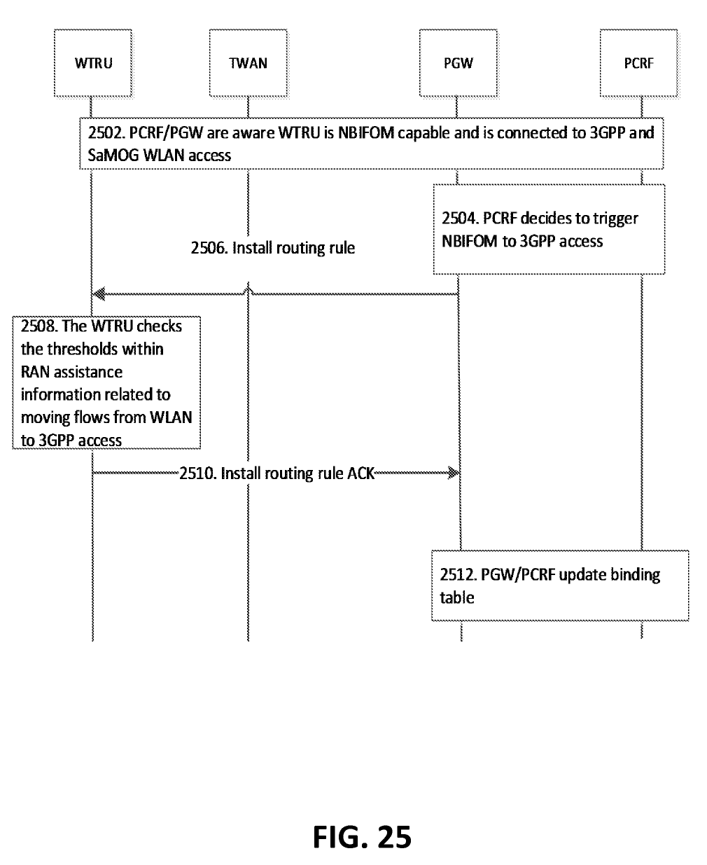

A WTRU may receive network-initiated NBIFOM from the Core Network to move IP flows to 3GPP access and/or to WLAN access. For example, if the WTRU receives a network-initiated NBIFOM to move IP flows to the 3GPP access, among other scenarios, the WTRU may use the RAN assistance thresholds as shown in the FIG. 25. FIG. 25 illustrates an example of RAN assistance information for a network-initiated NBIFOM trigger to move IP flows to 3GPP access. In FIG. 25, the NW-initiated NBIFOM may be transmitted from the PCRF/PGW, for example. The network-initiated NBIFOM may be transmitted from other network nodes as well.

At 2502, the WTRU may be connected to 3GPP and WLAN access. The PGW may be aware that the WTRU is NBIFOM capable (e.g., the WTRU may provide NBIFOM indication via PCO). At 2504, the PCRF may decide to trigger a network-initiated NBIFOM procedure of one or more IP flows to the 3GPP access and/or may transmit an indication to the PGW.

At 2506, the PGW may construct one or more routing rules (e.g., similar to those shown in Tables 1 and 2) and/or may transmit it/them to the WTRU (e.g., via an S2a connection towards the TWAN of the WLAN access).

At 2508, perhaps for example if the WTRU is authorized to use RAN rules, among other scenarios, the WTRU may check for RAN assistance information provided by the RAN. The WTRU may check one or more of the following thresholds (e.g., per availability) to evaluate whether the IP flows may be moved to the 3GPP access: Thresh_{ServingOffloadWLAN, HighP}; Thresh_{ServingOffloadWLAN, HighQ}; Thresh_{ChUtilWLAN, High}; Thresh_{BackhRateDLWLAN, Low}; Thresh_{BackhRateULWLAN, Low}; Thresh_{RCPIWLAN, Low}; and/or Thresh_{RSNIWLAN, Low}.

Thresh_{ServingoffloadWLAN, HighP}: RSRP threshold (for E-UTRAN)/CPICH RSCP threshold (for UTRAN FDD)/P-CCPCH threshold (for UTRAN TDD that may be used by the WTRU for traffic steering to (E-)UTRAN for example if Qrxlevmeas>Thresh_{ServingOffloadWLAN, HighP}.

Thresh_{ServingoffloadWLAN, HighQ}: RSRQ threshold (for E-UTRAN)/CPICH EC/N0 threshold (for UTRAN FDD) that may be used by the WTRU for traffic steering to (E-) UTRAN for example if Qqualmeas>Thresh_{ServingOffloadWLAN, HighQ}.

Thresh_{ChUtilWLAN, High}: WLAN channel utilization (BSS load) threshold that may be used by the WTRU for traffic steering to (E-)UTRAN for example if ChannelUtilizationWLAN>Thresh_{ChUtilWLAN, High}.

Thresh_{BackhRateDLWLAN, Low}: backhaul available downlink bandwidth threshold that may be used by the WTRU for traffic steering to (E-)UTRAN for example if BackhaulRateDlWLAN<Thresh_{BackhRateDLWLAN, Low}.

Thresh_{BackhRateULWLAN, Low}: backhaul available uplink bandwidth threshold that may be used by the WTRU for traffic steering to (E-)UTRAN for example if BackhaulRateDlWLAN<Thresh_{BackhRateDLWLAN, Low}.

Thresh_{RCPIWLAN, Low}: RCPI threshold that may be used by the WTRU for traffic steering to (E-)UTRAN for example if RCPI<Thresh_{RCPIWLAN, Low}.

Thresh_{RSNIWLAN, Low}: RSNI threshold that may be used by the WTRU for traffic steering to (E-)UTRAN for example if RSNI<Thresh_{RSNIWLAN, Low}.

Qrxlevmeas and/or Qqualmeas are the measurements for the serving (E-)UTRAN cell. ChannelUtilizationWLAN is the WLAN channel utilization value from BSS Load IE obtained from 802.11 (Beacon and/or Probe Response) signaling. BackhaulRateDlWLAN may be calculated as the Downlink Speed*(1−Downlink Load/255), where the downlink speed and/or load parameters may be drawn from the WAN Metrics element obtained via ANQP signaling from WFA HS 2.0. BackhaulRateUlWLAN is calculated as the Uplink Speed*(1−Uplink Load/255), where the uplink speed and/or load parameters may be drawn from the WAN Metrics element obtained via ANQP signaling from WFA HS 2.0. RCPI is the WLAN received channel power indicator. RSNI is the WLAN received signal to noise indicator.

At 2510, the WTRU may transmit an acknowledge message to the PGW. The ACK may inform the PGW whether the WTRU has moved the one or more flows to the 3GPP access and/or has rejected the request (e.g. in whole or in part) due to threshold conditions not being met. At 2512, the PGW and/or the PCRF (e.g., via PCC signaling) may update accordingly their binding table.

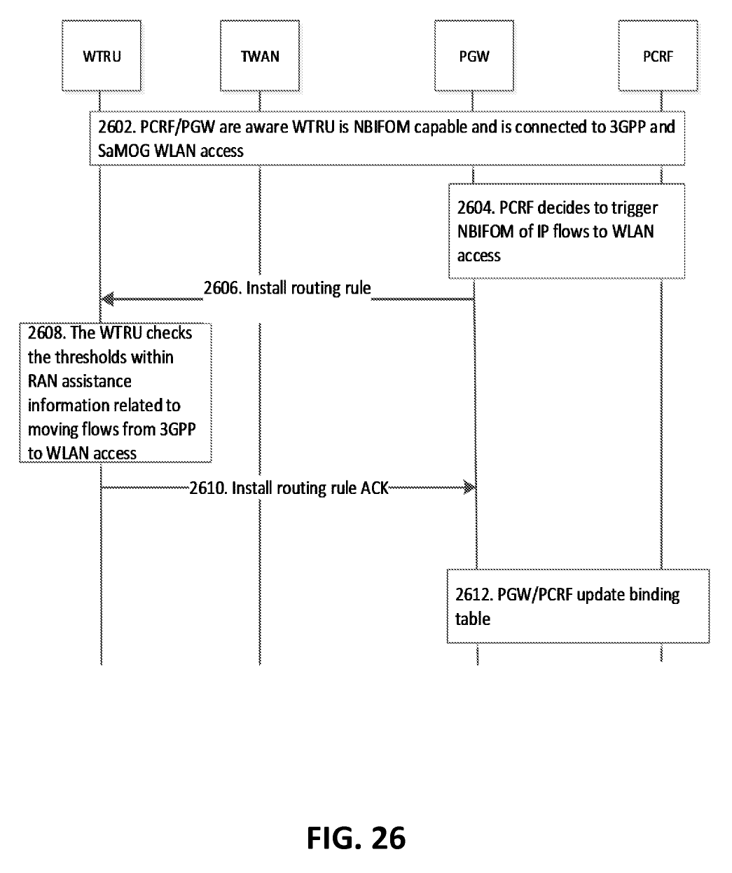

FIG. 26 illustrates an example of RAN assistance information for a network-initiated NBIFOM trigger to move one or more IP flows to WLAN access. At 2602, the WTRU may be connected to 3GPP and WLAN access. The PGW may be aware that the WTRU is NBIFOM capable (e.g., WTRU may provide NBIFOM indication via PCO).

At 2604, the PCRF may decide to trigger a network-initiated NBIFOM procedure of one or more IP flows to the WLAN access and/or may transmit an indication to the PGW. At 2606, the PGW may construct one or more routing rules (e.g., similar those shown in Tables 1 and 2) and/or transmit it/them to the WTRU (e.g., via an S2a connection towards the TWAN of the WLAN access).

At 2608, perhaps for example if the WTRU is authorized to use RAN rules, among other scenarios, the WTRU may check for RAN assistance information provided by the RAN. The WTRU may check one or more of the following thresholds (e.g., per availability) perhaps to evaluate whether the IP flows may be moved to the WLAN access: Thresh_{ServingOffloadWLAN, LowP}; Thresh_{ServingOffloadWLAN, LowQ}; Thresh_{ChUtilWLAN, Low}; Thresh_{BackhRateDLWLAN, High}; Thresh_{BackhRateULWLAN, High}; Thresh_{RCPIWLAN, High}; Thresh_{RSNIWLAN, High}; and/or Tsteering_{WLAN}.

Thresh_{ServingOffloadWLAN, LowP}: RSRP threshold (for E-UTRAN)/CPICH RSCP threshold (for UTRAN FDD)/P-CCPCH threshold (for UTRAN TDD), that may be used by the WTRU for traffic steering to WLAN for example if Qrxlevmeas<Thresh_{ServingOffloadWLAN, LowP}.

Thresh_{ServingOffloadWLAN, LowQ}: RSRQ threshold (for E-UTRAN)/CPICH E_{C}/N₀ threshold (for UTRAN FDD) that may be used by the WTRU for traffic steering to WLAN for example if Qqualmeas<Thresh_{ServingOffloadWLAN, LowQ}.

Thresh_{ChUtilWLAN, Low}: WLAN channel utilization (BSS load) threshold that may be used by the WTRU for traffic steering to WLAN for example if ChannelUtilizationWLAN<Thresh_{ChUtilWLAN, Low}.

Thresh_{BackhRateDLWLAN, High}: backhaul available downlink bandwidth threshold that may be used by the WTRU for traffic steering to WLAN for example if BackhaulRateDlWLAN>Thresh_{BackhRateDLWLAN, High}.

Thresh_{BackhRateULWLAN, High}: backhaul available uplink bandwidth threshold that may be used by the WTRU for traffic steering to WLAN for example if BackhaulRateUlWLAN>Thresh_{BackhRateULWLAN, High}.

Thresh_{RCPIWLAN, High}: RCPI threshold that may be used by the WTRU for traffic steering to WLAN for example if RCPI>Thresh_{RCPIWLAN, High}.

Thresh_{RSNIWLAN, High}: RSNI threshold that may be used by the WTRU for traffic steering to WLAN for example if RSNI>Thresh_{RSNIWLAN, High}.

Tsteering_{WLAN}: timer value Tsteering_{WLAN} during which the one or more rules may be fulfilled for example before starting traffic steering between E-UTRAN and WLAN.

Qrxlevmeas and Qqualmeas are measurements for the serving (E-)UTRAN cell. ChannelUtilizationWLAN is the WLAN channel utilization value from BSS Load IE obtained from 802.11 (Beacon and/or Probe Response) signaling. BackhaulRateDlWLAN is calculated as the Downlink Speed*(1−Downlink Load/255), where the downlink speed and/or load parameters may be drawn from the WAN Metrics element obtained via ANQP signaling from WFA HS 2.0. BackhaulRateUlWLAN may be calculated as the Uplink Speed*(1−Uplink Load/255), where the uplink speed and/or load parameters may be drawn from the WAN Metrics element obtained via ANQP signaling from WFA HS 2.0. RCPI is the WLAN received channel power indicator. RSNI is the WLAN received signal to noise indicator.

At 2610, the WTRU may transmit an acknowledge message to the PGW, for example, to inform the PGW whether the WTRU has moved the one or more flows to the WLAN access and/or has rejected the request (e.g. in whole or in part) perhaps due to threshold conditions not being met. At 2612, the PGW and/or the PCRF (e.g., via PCC signaling) may update accordingly their binding table.

One or more techniques contemplate that RAN assisted NBIFOM may utilize a traffic steering indication transmitted to the core network (CN) from the RAN. The RAN (for example, an eNB or RNC) may evaluate RAN rules for traffic steering. The RAN may decide to steer traffic to the WLAN and/or from the WLAN and/or transmit a traffic steering indication (for traffic steering to WLAN or from WLAN) to the CN (for example, SGW/PGW, SGSN, PCRF, MME). This indication may include the one or more WLAN identifiers to which the traffic may be routed and/or from which the traffic may be routed. The WLAN identifiers may be provisioned in the RAN by the operator and/or signalled to the RAN by the CN.

The CN may be configured with one or more rules for co-existence, between CN decisions for access network selection and/or traffic routing (for example, based on operator policies) and RAN decisions for access network selection and/or traffic routing (for example, based on RAN rules implemented in the RAN).

The CN may arbitrate between RAN and CN respective internal access network selection and/or traffic routing decision process and/or may make a (e.g. final) decision of access network selection and/or traffic routing. For example, the CN may uphold a RAN decision and/or may override a RAN decision. The CN may initiate NBIFOM as a result of the outcome of arbitration, for example, among other scenarios.

One or more techniques contemplate that the RAN may provide a traffic steering indication to the PCRF/PGW. An interface (e.g., a fresh interface and/or heretofore unused interface) may be used between the RAN and the PGW, perhaps for example in order to support the traffic steering indication. In some techniques, the RAN may report the traffic steering decision within existing GTP user plane (via GTP-U packet) and/or GTP control plane signaling via the MME, for example. Once the PGW receives the traffic steering decision, for example, among other scenarios, the PGW may initiate network-initiated NBIFOM. The PGW may check with the PCRF as to whether network-initiated NBIFOM may be allowed.

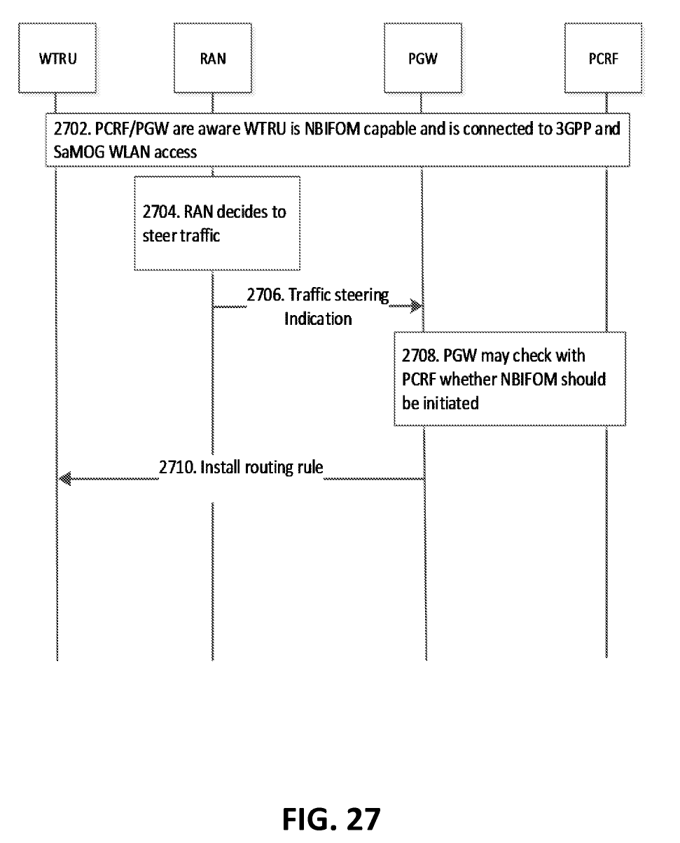

FIG. 27 illustrates an example of RAN initiated traffic steering. At 2702, the WTRU may be connected to 3GPP and WLAN access. At 2704, the RAN may decide to initiate traffic steering to WLAN and/or 3GPP based on WLAN and/or 3GPP signal strength and/or load measurements.

At 2706, the RAN may transmit an indication to PGW to initiate traffic steering. The indication may include WLAN identifiers where traffic is to be steered. In some techniques, the RAN may transmit a traffic steering indication via a direct interface to the PGW. In some techniques, the eNB may transmit the indication within the existing user plane traffic of the WTRU (for example, an indication within GTP-U packets). In some techniques, the RAN may transmit the indication through the WTRUs existing control plane signaling (for example, when the WTRU transmits traffic area updates).

At 2708, the PGW may check with the PCRF as to whether NBIFOM may be initiated, perhaps for example, taking into account user subscription information, among other scenarios. The PCRF may have one or more local policies for access network selection and/or traffic steering. The PCRF may take into account the RAN steering indication and/or may decide, perhaps for example based on local policies, whether it may be accepted and/or might not be accepted. At 2710, the PGW may transmit a network initiated NBIFOM, for example by providing one or more routing rules information to the WTRU (e.g., via the TWAN and/or via 3GPP signaling).

One or more techniques contemplate that RAN assisted NBIFOM may utilize traffic steering commands from the RAN to the core network. The RAN (for example, eNB, RNC) may evaluate RAN rules for traffic steering. The RAN may decide to steer traffic to WLAN and/or from WLAN and/or may transmit a traffic steering command (e.g., for traffic steering to WLAN and/or from WLAN) to the CN (for example, SGW/PGW, SGSN, PCRF, MME). This traffic steering command may include the one or more WLAN identifiers to which the traffic may be routed and/or from which the traffic should be routed. The CN may initiate NBIFOM based on the RAN command, for example among other scenarios.

In some techniques, the RAN may provide the traffic steering command to the PGW. A new interface (e.g., fresh or heretofore unused) may be used between the RAN and the PGW, perhaps for example in order to support the traffic steering command. The RAN may report the traffic steering decision within existing GTP user plane (e.g., via GTP-U packet) and/or GTP control plane signaling (e.g., via the MME). Once the PGW receives the traffic steering decision, for example, among other scenarios, the PGW may initiate network-initiated NBIFOM. The PGW may also check with the PCRF as to whether network-initiated NBIFOM may be allowed, perhaps for example based on subscription information, among other scenarios.

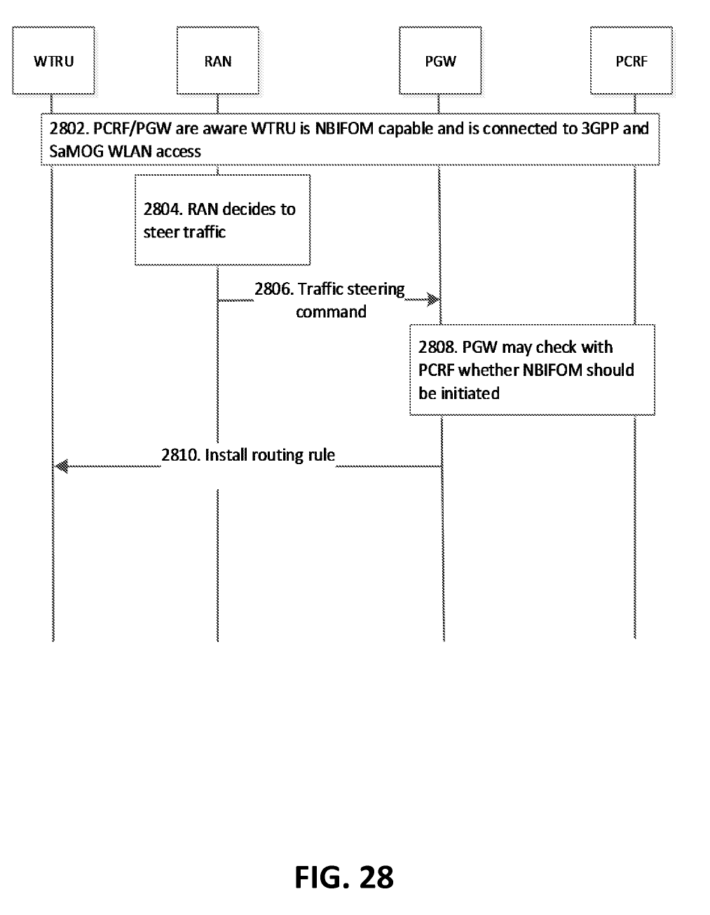

FIG. 28 illustrates an example of RAN initiated traffic steering. At 2802, the WTRU may be connected to 3GPP and WLAN access. At 2804, the RAN may decide to initiate traffic steering to WLAN and/or 3GPP, perhaps for example based on WLAN and/or 3GPP signal strength and/or load measurements.

At 2806, the RAN may transmit a traffic steering command to PGW, for example to initiate traffic steering. The signaling may also include one or more WLAN identifiers where traffic is to be steered. In some techniques, the RAN may transmit a traffic steering command via a direct interface to the PGW. In some techniques the RAN may transmit the indication within the existing user plane traffic of the WTRU (for example, an indication within GTP-U packets). In some techniques, the RAN may transmit the command through the WTRUs existing control plane signaling (for example, when the WTRU transmits traffic area updates).

At 2808, the PGW may check with PCRF as to whether NBIFOM may be initiated, for example, perhaps for example taking into account user subscription information. At 2810, the PGW may transmit a network initiated NBIFOM, for example by providing one or more routing rules information to the WTRU (e.g., via the TWAN and/or via 3GPP signaling).

One or more techniques contemplate that a RAN assisted NBIFOM may utilize a decision to steer traffic from the CN based on the RAN assistance information transmitted by the RAN. The RAN may provide one or more RAN assistance parameters to the CN (for example, SGW/PGW, SGSN, PCRF, MME). There may be one or more sets of RAN assistance parameters from traffic steering to WLAN and one or more sets of RAN assistance parameters from traffic steering from WLAN.

The CN may be configured with one or more access network selection and/or traffic steering rules which may include one or more operator policies and/or rules that may make use of one or more RAN assistance parameters. The CN may make access network selection and/or traffic routing decisions based on these rules, for example. The CN may initiate NBIFOM as a result of the decision.

The following are non-limiting examples of RAN assistance parameters.

Thresh_{ServingOffloadWLAN, LowP} which specifies the RSRP threshold (in dBm) that may be used by the WTRU for traffic steering to WLAN.

Thresh_{ServingOffloadWLAN, HighP} which specifies the RSRP threshold (in dBm) that may be used by the WTRU for traffic steering to E-UTRAN.

Thresh_{ServingOffloadWLAN, LowQ} which specifies the RSRQ threshold (in dB) that may be used by the WTRU for traffic steering to WLAN.

Thresh_{ServingOffloadWLAN, HighQ} which specifies the RSRQ threshold (in dB) that may be used by the WTRU for traffic steering to E-UTRAN.

Thresh_{ChUtilWLAN, Low} which specifies the WLAN channel utilization (BSS load) threshold that may be used by the WTRU for traffic steering to WLAN.

Thresh_{ChUtilWLAN, High} which specifies the WLAN channel utilization (BSS load) threshold that may be used by the WTRU for traffic steering to E-UTRAN.

Thresh_{BackhRateDLWLAN, Low} which specifies the backhaul available downlink bandwidth threshold that may be used by the WTRU for traffic steering to E-UTRAN.

Thresh_{BackhRateDLWLAN, High} which specifies the backhaul available downlink bandwidth threshold that may be used by the WTRU for traffic steering to WLAN.

Thresh_{BackhRateULWLAN, Low} which specifies the backhaul available uplink bandwidth threshold that may be used by the WTRU for traffic steering to E-UTRAN.

Thresh_{BackhRateULWLAN, High} which specifies the backhaul available uplink bandwidth threshold that may be used by the WTRU for traffic steering to WLAN.

Thresh_{RCPIWLAN, Low} which specifies the RCPI threshold that may be used by the WTRU for traffic steering to E-UTRAN.

Thresh_{RCPIWLAN, High} which specifies the RCPI threshold that may be used by the WTRU for traffic steering to WLAN.

Thresh_{RSNIWLAN, Low} which specifies the RSNI threshold that may be used by the WTRU for traffic steering to E-UTRAN.

Thresh_{RSNIWLAN, High} which specifies the RSNI threshold that may be used by the WTRU for traffic steering to WLAN.

Thresh_{BeaconRSSIWLAN, Low} which specifies the Beacon RSSI threshold that may be used by the WTRU for traffic steering from WLAN to E-UTRAN.

Thresh_{BeaconRSSIWLAN, High} which specifies the Beacon RSSI threshold that may be used by the WTRU for traffic steering from E-UTRAN to WLAN.

Tsteering_{WLAN} which specifies the timer value Tsteering_{WLAN} during which the rules may be fulfilled perhaps for example before starting traffic steering between E-UTRAN and WLAN.

The SSIDs, BSSIDs, and/or HESSIDs (perhaps for example only such SSIDs, BSSIDs and/or HESSIDs) which may have been provided in the one or more parameters may be considered for traffic steering between E-UTRAN and WLAN, for example based on the rules disclosed herein, among other scenarios.

The following are example of rules (in RAN and/or in the CN) that may use RAN assistance parameters.

Traffic steering from E-UTRAN to WLAN are satisfied for a time interval Tsteering_{WLAN}.

For Traffic steering from E-UTRAN to WLAN are satisfied for a time interval Tsteering_{WLAN} in the E-UTRAN serving cell: RSRPmeas<Thresh_{ServingOffloadWLAN, LowP}; and/or RSRQmeas<Thresh_{ServingOffloadWLAN, LowQ}. For Traffic steering from E-UTRAN to WLAN are satisfied for a time interval Tsteering_{WLAN} in the target WLAN: ChannelUtilizationWLAN<Thresh_{ChUtilWLAN, Low}; and/or BackhaulRateDlWLAN>Thresh_{BackhRateDLWLAN, High}; and/or BackhaulRateUlWLAN>Thresh_{BackhRateULWLAN, High}; and/or BeaconRSSI>Thresh_{BeaconRSSIWLAN, High}.

For Traffic steering from E-UTRAN to WLAN are satisfied for a time interval Tsteering_{WLAN} in the source WLAN: ChannelUtilizationWLAN>Thresh_{ChUtilWLAN, High}; and/or BackhaulRateDlWLAN<Thresh_{BackhRateDLWLAN, Low}; and/or BackhaulRateUlWLAN<Thresh_{BackhRateULWLAN, Low}; and/or BeaconRSSI<Thresh_{BeaconRSSIWLAN, Low}. For Traffic steering from E-UTRAN to WLAN are satisfied for a time interval Tsteering_{WLAN} in the target E-UTRAN cell: RSRPmeas>Thresh_{ServingOffloadWLAN, HighP}; and/or RSRQmeas>Thresh_{ServingOffloadWLAN, HighQ}.

Table 4 illustrates one or more quantities to which the rules refer.

TABLE 4

| | | | |
|---|---|---|---|
| 1.1 | ChannelUtilizationWLAN | 1.2 | WLAN channel utilization (see for example TS |
| | | | 36.304) |
| 1.3 | BackhaulRateDlWLAN | 1.4 | WLAN DLBandwidth (see for example TS |
| | | | 36.304) |
| 1.5 | BackhaulRateUlWLAN | 1.6 | WLAN ULBandwidth (see for example TS |
| | | | 36.304) |
| 1.7 | BeaconRSSI | 1.8 | WLAN Beacon RSSI (see for example TS |
| | | | 36.304) |
| 1.9 | RSRPmeas | 1.10 | Qrxlevmeas in RRC_IDLE, and PCell RSRP |
| | | | in RRC_CONNECTED (see for example TS |
| | | | 36.331). |
| 1.11 | RSRQmeas | 1.12 | Qqualmeas in RRC_IDLE, and PCell RSRQ |
| | | | in RRC_CONNECTED (see for example TS |
| | | | 36.331) |

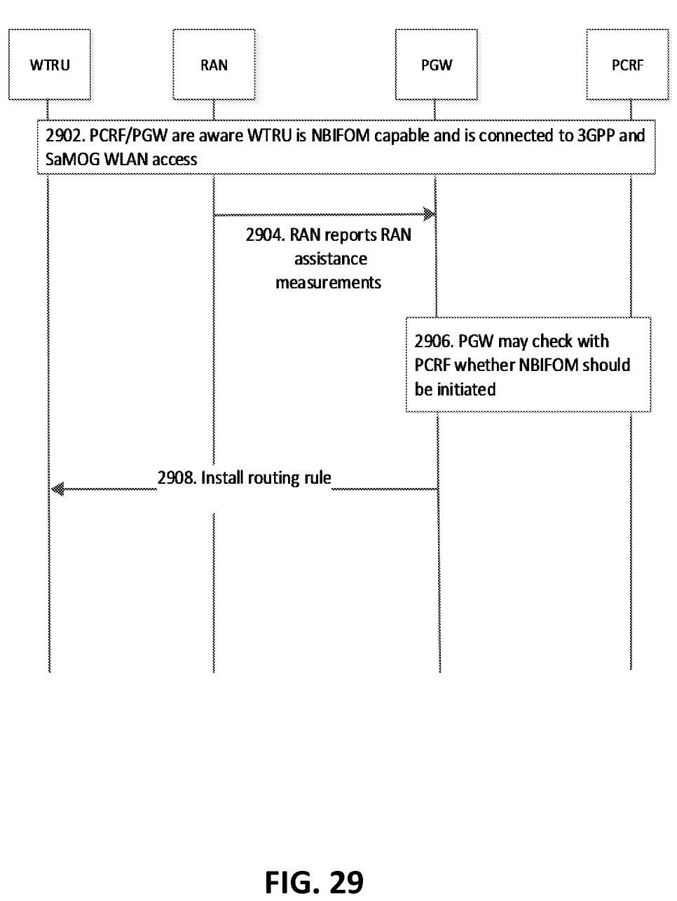

FIG. 29 illustrates an example of RAN assisted NBIFOM by providing RAN assistance information to the PGW.

At 2902, the WTRU may be connected to a 3GPP access and a WLAN access. At 2904, the RAN may report RAN assistance information directly to PGW. A new interface (e.g., fresh or heretofore unused) between the RAN and PGW may be used.

At 2906, perhaps for example when thresholds are met, among other scenarios, the PGW may check with PCRF as to whether NBIFOM may be initiated. The PGW may report RAN assistance information to PCRF in this element. At 2908, the PGW may transmit a network initiated NBIFOM for example by providing one or more routing rules information to the WTRU (e.g., via the TWAN and/or via 3GPP signaling).

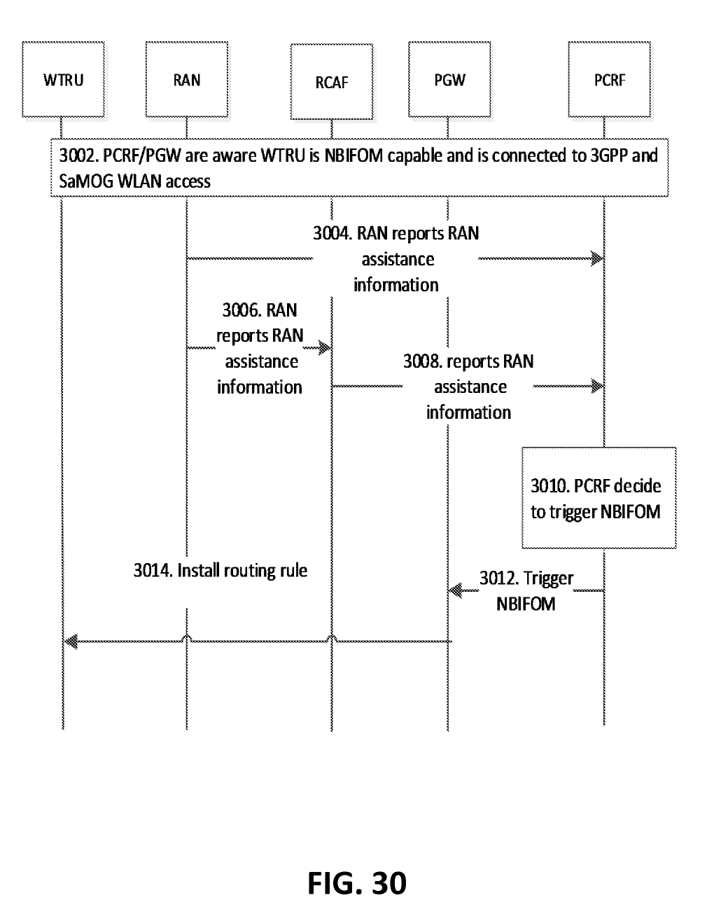

FIG. 30 illustrates an example of RAN assisted NBIFOM by providing RAN assistance information to the PCRF.

At 3002, the WTRU may be connected to 3GPP and WLAN access. At 3004, the RAN may report RAN assistance information directly to PCRF. A new interface (e.g., fresh or heretofore unused) between the RAN and PGW may be used.

At 3006, the RAN may report RAN assistance information to the RCAF (Resource Congestion Awareness Function). At 3008, the RCAF may forward the RAN assistance information to the PCRF via Np reference point.

At 3010 and 3012, perhaps for example based on the RAN assistance information, among other scenarios, the PCRF may decide to initiate NBIFOM. At 3014, the PGW may transmit a network initiated NBIFOM for example by providing one or more routing rules information to the WTRU (e.g., via the TWAN or via 3GPP signaling).

One or more techniques contemplate that the WTRU and the PGW may exchange one or more routing rules information via NAS signaling (or WLCP/EAP signaling via a SaMOG WLAN) as described in Tables 1 and 2. The one or more routing rules information may be provided within the TFT information. One or more of the following parameters may be included within the TFT information: NBIFOM indication and/or NBIFOM direction (for example, 3GPP or WLAN).

For example, for a WTRU-initiated NBIFOM, among other scenarios, the WTRU may construct a traffic flow aggregate that may contain an aggregate of packet filters in the uplink direction that are included in a WTRU requested bearer resource allocation procedure and/or a WTRU requested bearer resource modification procedure. For one or more, or each packet filter the WTRU may provide an NBIFOM direction to 3GPP and/or WLAN. Perhaps for example, when the PGW receives the traffic flow aggregate, among other scenarios, the PGW may identify the corresponding packet filters in the downlink direction and/or may construct the Uplink Traffic Flow Template and/or Downlink Traffic Flow Template for one or more, or each packet filter. For example, if the PCRF has approved the WTRU-initiated NBIFOM, the PGW may also include in the TFT the NBIFOM direction. Perhaps for example when the WTRU receives the Traffic Flow Templates (e.g., UL and/or DL) from the PGW, among other scenarios, the WTRU may move IP flows accordingly.

For example, for a NW-initiated NBIFOM, among other scenarios, the PGW may construct the traffic flow template including packet filters in the downlink and/or uplink direction. For one or more, or each, packet filter within UL TFT and/or DL TFTs, the PGW may include an NBIFOM direction. Perhaps for example if the WTRU approves the network-initiated NBIFOM (e.g., based on radio conditions and/or RAN assistance thresholds), the WTRU may move the one or more flows accordingly.

Although features and elements are described above and/or illustrated in the Figures in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A wireless transmit/receive unit (WTRU), comprising:
a processor, the processor configured at least to:
establish communication via a first access network, the first access network being a Trusted Wireless Local Access Network (TWAN);
establish communication via a second access network, the second access network being a Third Generation Partnership Project (3GPP) Access Network;
direct a first Internet Protocol (IP) flow via the first access network;
detect a loss of connectivity with the first access network; and
create one or more routing rules for redirection of the first IP flow via the second access network upon the loss of connectivity with the first access network; and
a transmitter, the transmitter configured at least to:
send an indication of the loss of connectivity with the first access network toward a node of a core network via the second access network in a Request Bearer Resource Modification message, the node of the core network being a Packet Data Network (PDN) gateway (PGW); and
send the one or more routing rules for the redirection of the first IP flow toward the node of the core network via the second access network in the Request Bearer Resource Modification message.

2. (canceled)

3. (canceled)

4. The WTRU of claim 1, wherein the processor is further configured such that the communication via the first access network and the communication via the second access network are established using the same Access Point Name (APN).

5. (canceled)

6. (canceled)

7. (canceled)

8. The WTRU of claim 1, wherein the processor is further configured to direct a second IP flow via the second access network.

9. The WTRU of claim 1, wherein the first IP flow is at least one of: a WTRU-initiated Network-based IP flow mobility (NBIFOM) triggered IP flow, or a Network-initiated NBIFOM triggered IP flow.

10. The WTRU of claim 1, wherein the redirection of the first IP flow is a seamless redirection from the first access network to the second access network.

11. The WTRU of claim 1, wherein the processor is further configured to:
implement bearer modification to support the redirection of the first IP flow via the second access network; and
redirect the first IP flow via the second access network based on the bearer modification.

12. The WTRU of claim 11, wherein the bearer modification is initiated via the node of the core network.

13. The WTRU of claim 1, wherein the processor is further configured to:
detect connectivity with the first access network, and the transmitter is further configured to:
send, via the second access network, an indication of the connectivity with the first access network toward a node of a core network.

14. The WTRU of claim 13, wherein the transmitter is further configured such that the indication of the connectivity with the first access network is sent as part of Protocol Configuration Options (PCO) information.

15. The WTRU of claim 14, wherein the transmitter is further configured such that the PCO is sent in at least one of: a Request Bearer Resource Modification message, or an Attach message.

16. The WTRU of claim 1, wherein the processor is further configured to:
detect connectivity with the first access network, and the transmitter is further configured to:
send, via the second access network, an indication that the WTRU supports Network-initiated Network-based IP flow mobility (NBIFOM) toward a node of a core network.

17. The WTRU of claim 13, wherein the first access network is a Trusted Wireless Local Access Network (TWAN) capable of an S2a Mobility based on General Packet Radio Service (GPRS) Tunneling Protocol (GTP) (SaMOG).

18. The WTRU of claim 16, wherein the transmitter is further configured such that the indication that the WTRU supports Network-initiated NBIFOM is sent as part of Protocol Configuration Options (PCO) information.

19. The WTRU of claim 18, wherein the transmitter is further configured such that the PCO is sent in at least one of: a Request Bearer Resource Modification message, or an Attach message.

20. The WTRU of claim 19, wherein the transmitter is further configured to remove from the PCO the indication that the WTRU supports Network-initiated NBIFOM upon the loss of connectivity with the first access network.

21. The WTRU of claim 14, wherein the transmitter is further configured to remove from the PCO the indication of the connectivity with the first access network upon the loss of connectivity with the first access network.

22. The WTRU of claim 13, wherein the first IP flow is a Network-initiated Network-based IP flow mobility (NBIFOM) triggered IP flow, and the WTRU further comprises:
a receiver, the receiver configured at least to:
receive a trigger to direct the first IP flow via the first access network from the first node in response to the indication of the connectivity with the first access network.

23. The WTRU of claim 16, wherein the first IP flow is a Network-initiated Network-based IP flow mobility (NBIFOM) triggered IP flow, and the WTRU further comprises:
a receiver, the receiver configured at least to:
receive a trigger to direct the first IP flow via the first access network from the first node in response to the indication that the WTRU supports Network-initiated NBIFOM.

24. (canceled)

25.-30. (canceled)
